(19) United States
(12) Patent Application Publication
(10) Pub. No.: US 2005/0125486 A1
(43) Pub. Date: Jun. 9, 2005

(54) Decentralized operating system

(75) Inventors: Georgios Chrysanthakopoulos, Redmond, WA (US); Henrik F. Nielsen, Seattle, WA (US); George Moore, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/718,199

(22) Filed: Nov. 20, 2003

(51) Int. Cl. G06F 15/16; G06F 15/173; G06F 3/00; G06F 13/00; G06F 9/44; G06F 9/46

(52) U.S. Cl. 709/201; 719/320; 719/313

(57) ABSTRACT

Several primitives form the minute essence of services, which are organizational primitives of decentralized operating systems. These primitives include a designation primitive, which comprises a port, such as the ports identifiable by the URI; a behavioral primitive, which comprises the unilateral contract; and a communication primitive, which includes a set of message types known by all services for exchanging messages in accordance with unilateral contracts.

### FIELD OF THE INVENTION

The present invention relates generally to operating systems, and more particularly, to a non-centralized operating system comprising numerous services that are interoperable to control and coordinate usage of resources.

### BACKGROUND OF THE INVENTION

The history of computer science, like the history of political science, progresses toward decentralization. In the history of the rise of nation-states, for example, authority first resided in monarchies, government by a single individual who ruled in his own interests over the many. The struggle between the powerful upper strata of societies and the monarch eventually produced aristocracy, government by a select few who ruled in their own interests over the many. With the experience of centuries, the people of the world collectively came to realize that good governments are those that serve the general welfare instead of the narrow interests of individuals or of the few. It is this realization that gave rise to democracy, government by the many of the many.

Computer systems have progressed similarly: Mainframe computers, introduced in the early 1950s, were highly centralized, large enough to fill an entire room and with glass walls through which visitors could gawk at flashing vacuum tubes. Users brought their work to the mainframe computers to be processed in a manner not dissimilar to commoners seeking an audience with the king. Minicomputers, arriving in the early 1960s, were built from transistors instead of vacuum tubes, and allowed organizations using them to enjoy a higher level of input and output from users connected to the minicomputers via dumb terminals, marking the start of decentralization. Appearing in the mid-1970s were microcomputers, in which large-scale integration enabled thousands of circuits to be incorporated on a single chip, called a microprocessor. Less powerful than minicomputers and mainframes when they first appeared, microcomputers—essentially, in today's terms, desktop PCs—have nevertheless continued to evolve and have placed in the hands of ordinary people machines that are more powerful than the mainframe computers of yesteryear, and at a fraction of the cost. The more recent merging of PCs and the Internet illuminates the possibilities for the further decentralization of computers by allowing not only people but also machines and other resources to cooperate from afar and locally to form functionalities richer than previously possible.

While hardware resources have continued the trend toward decentralization, operating systems, as an essential part of many computer systems, have not progressed as quickly. FIG. 1 shows a centralized operating system: Linux operating system 101. A computer system 100 comprises four major components: the hardware, the operating system, the applications, and the users. The hardware, such as the central processing unit 110, the memory 112, and the input/output devices 114, comprises the resources. The applications, such as applications 106, include compilers, database systems, games, business programs, and so on, and define the ways in which the resources 110-114 are used to solve the computing problems of the users (people, devices, and other computers). The Linux operating system 101 controls and coordinates the use of the hardware 110-114 among the applications 106 for the various users.

The Linux operating system 101 centralizes control and coordination by employing three tightly coupled portions of code similar to other UNIX operating system variants: a kernel 102, system libraries 104, and system utilities (daemons) 108. The kernel 102 forms the core of the Linux operating system 101. The kernel 102 provides all the functionality necessary to run processes, and it provides protected access to hardware resources 110-114. System libraries 104 specify a standard set of functions and application programming interfaces through which applications can interact with the kernel 102, and which implement much of the Linux operating system 101. A point of departure from the UNIX operating system variants lies in the operating system interface of the Linux operating system 101, which is not directly maintained by the kernel 102. Rather, the applications 106 make calls to the system libraries 104, which in turn call the operating system functions of the kernel 102 as necessary. System utilities (daemons) 108 are programs that perform individual, specialized management tasks, such as responding to incoming network connections, housekeeping, or maintenance utilities without being called by the user.

The kernel 102 is created as a single, monolithic architecture (revealing the UNIX pedigree of the Linux operating system 101). The main reason for the single binary is to improve the overall performance of the Linux operating system 101 by concentrating power, authority, control, and coordination of resources. Everything is tightly coupled in the kernel 102, such as kernel code and data structures. Everything is kept in a single address space, and thus, no context switches are necessary when a process calls an operating system function or when a hardware interrupt is delivered. Not only does the core scheduling and virtual memory code occupy this address space, but all kernel code, including all device drivers, file systems, and networking code, is present in the same single address space.

One problem with such a tightly coupled design is that its interfaces are fragile. A slight change, such as a change in the application programming interface to an operating system function, causes instability that reverberates throughout the Linux operating system 101. Another problem is that by exposing device drivers in the single address space, these device drivers can act as Trojan horses for housing unreliable code that can deadlock the Linux operating system 101.

A further problem with the centralized operating system architecture of the Linux operating system 101 is that it continues the fiction that began with mainframe computers in the 1950s that all computation can be wholly accomplished by a single computer system. This architecture assumes that all resources are local to the computer system. All resources are addressed, discovered, loaded, used, and freed (and all are assumed to be) inside a single computer system. Today and for the foreseeable future, however, resources—and with the popularity of the Internet, user data—are scattered across a multiplicity of computer systems, often in different trust domains, and each with its own security policy.

Much like fitting square pegs into round holes, the use of remote procedure calls is an attempt to decentralize what is at its essence the centralized architecture of the Linux operating system 101. In a program, a procedure is a named sequence of statements, often with associated constants, data types, and variables, that usually performs a single task. A procedure can usually be called (executed) by other procedures, such as the main body of the program. A remote procedure call 206 is used when a procedure on one computer system 202 needs the computation capability of another procedure located on another computer system 204. See FIG. 2. When a remote procedure call 206 is made, an identifier of the remote procedure and its parameters are sent to a port of the remote computer system 204. At the remote computer system 204, a daemon listening at the port invokes the remote procedure (which is a local procedure on the remote computer system 204) with the sent parameters. In order for the invocation of procedures to work, local or remote, some form of binding has to take place. With a local procedure call, binding takes place during link, load, or execution time, during which a memory address replaces the procedure call. For a remote procedure call 206, binding ties not a memory address to the remote procedure call 206 (because the memory address of the computer system 202 is distinct from the memory address of the remote computer system 204), but instead the binding ties a port of the remote computer system 204 on which resides the remote procedure with the remote procedure call 206 on the local computer system 202.

The use of remote procedure calls is an exercise in contortion. The Linux operating system 101 presumes (and rightly so for the time it was designed) that resources needed by applications 106 should be known to the Linux operating system 101. A local procedure running on a Linux operating system must know at compile time the existence of a remote procedure, as a resource, on another Linux operating system. There is no process in place to discover remote procedures that may come into existence after the compilation of the local procedure. Thus, the presumption of the Linux operating system 101 that all resources are local applies even to resources that are beyond the trust domain in which the Linux operating system 101 resides. Such presumptions hinder rather than help decentralization.

In sum, centralized operating systems do not work well for large-scale computer systems, such as the Internet, that are decentralized. There are too many dependencies due to monolithic designs that date back to the days of mainframe computers. All resources are assumed to be local yet resources are increasingly available at the periphery rather than at the core. Without an operating system that can recognize decentralized resources and can coordinate these decentralized resources, near or far, to create functionalities desired by users, users may eventually no longer trust the computer system 100 to provide a desired computing experience, and demand for the computer system 100 will diminish over time in the marketplace. Thus, what is needed is a non-centralized mechanism to orchestrate computations both at the periphery and at the core without appealing to any centralized authority.

### SUMMARY OF THE INVENTION

In accordance with this invention, a system and method for providing a decentralized operating system is discussed. The system form of the invention includes services for representing resources. Each service includes a designation primitive, a behavioral primitive that comprises a unilateral contract, and a communication primitive. The system further includes a decentralized operating system for orchestrating the services executing on the computer system so as to control and coordinate resources.

In accordance with further aspects of this invention, the system form of the invention includes a networked system for networking computer systems. The networked system includes a first decentralized operating system executing on a computer system. The first decentralized operating system includes a first distributing kernel for designating uniform resource identifiers for a first set of services and distributing messages among the first set of services. Each service includes a unilateral contract. The unilateral contract expresses behaviors of the service.

In accordance with further aspects of this invention, the system form of the invention comprises a system that includes a decentralized operating system that includes a distributing kernel. The distributing kernel includes a URI manager for managing names. Each name constitutes a unique designation of a service at the computer system so that the service can be discovered. The system further includes a message dispatcher for forwarding messages among services. Each service is identifiable by a name managed by the URI manager and associated with a unilateral contract.

In accordance with further aspects of this invention, the method form of the invention comprises a method implemented on a computer system. The method includes assigning a first unique name to a first service upon request. The first service includes a first unilateral contract for expressing the behaviors of the first service. The method further includes distributing a message to the first service using the unique name. The message is sent by a second service having a second unique name. The second service includes a second unilateral contract for expressing the behaviors of the second service.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating a conventional computer system that comprises a centralized operating system;

FIG. 2 is a block diagram illustrating two computer systems communicating via remote procedure calls;

FIG. 3A is a block diagram illustrating a decentralized operating system for creating unity among a multiplicity of devices, content, applications, and people, according to one embodiment of the present invention;

FIG. 3B is a block diagram illustrating two services communicating with one another, according to one embodiment of the present invention;

FIGS. 3C-3D are unilateral contracts associated with services, according to one embodiment of the present invention;

FIG. 3E is a block diagram illustrating pieces of a system, and more particularly, a decentralized operating system, according to one embodiment of the present invention;

FIG. 3F is a block diagram illustrating pieces of a decentralized operating system, according to one embodiment of the present invention;

FIG. 3G is a block diagram illustrating pieces of a decentralized operating system, according to one embodiment of the present invention;

FIG. 3H is a block diagram illustrating components of a distributing kernel of a decentralized operating system, according to one embodiment of the present invention;

FIG. 3I is a block diagram illustrating a service loader of a decentralized operating system, according to one embodiment of the present invention;

FIG. 3J is a block diagram illustrating a uniform resource identifier (URI) manager of a distributing kernel, according to one embodiment of the present invention;

FIG. 3K is a block diagram illustrating a message dispatcher component of a distributing kernel of a decentralized operating system, according to one embodiment of the present invention;

FIG. 3L is a block diagram illustrating pieces of a network manager of a distributing kernel of a decentralized operating system, according to one embodiment of the present invention;

FIG. 3M is a block diagram illustrating concurrency of services, according to one embodiment of the present invention;

FIG. 3N is a block diagram illustrating decentralization and concurrency of services, according to one embodiment of the present invention;

FIG. 3O is a block diagram illustrating communication among services, according to one embodiment of the present invention;

FIG. 3P is a block diagram illustrating graphing relationships among multiple services, according to one embodiment of the present invention; and

FIGS. 4A-4I are process diagrams illustrating a method for executing a decentralized operating system, according to one embodiment of the present invention.

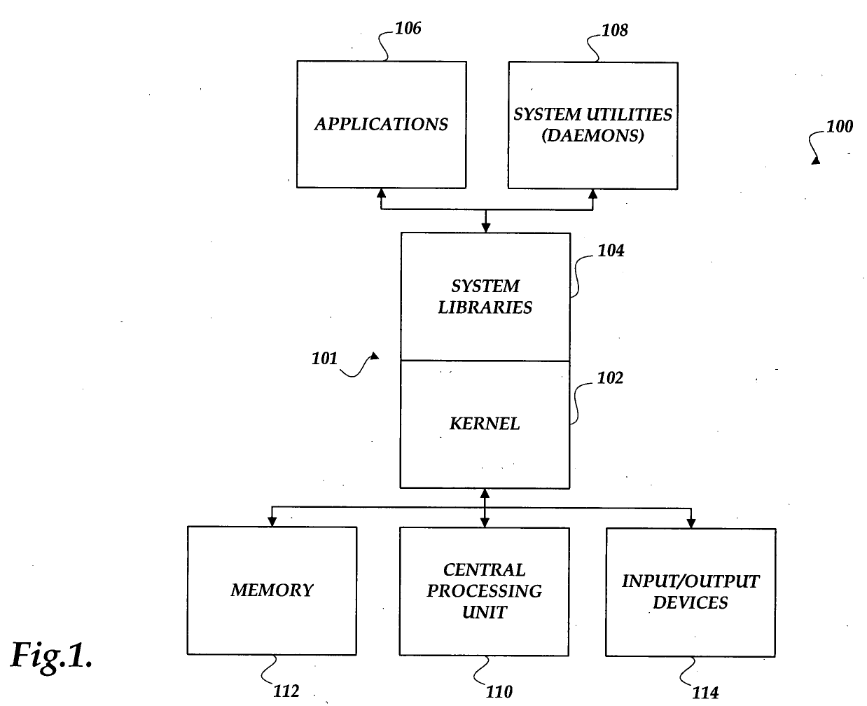

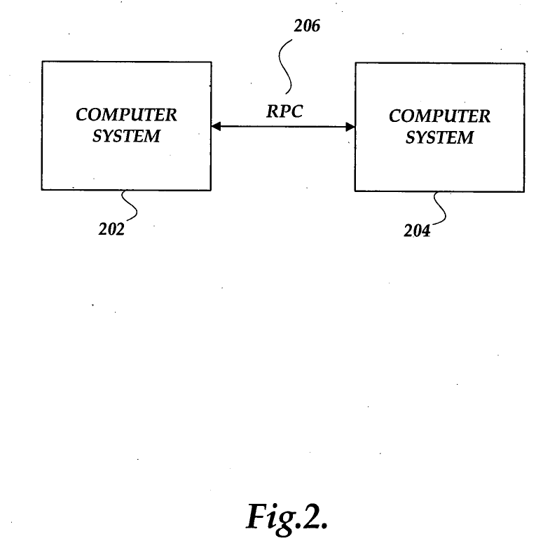

### DETAILED DESCRIPTION OF THE PREFERRED EMBODIMENT

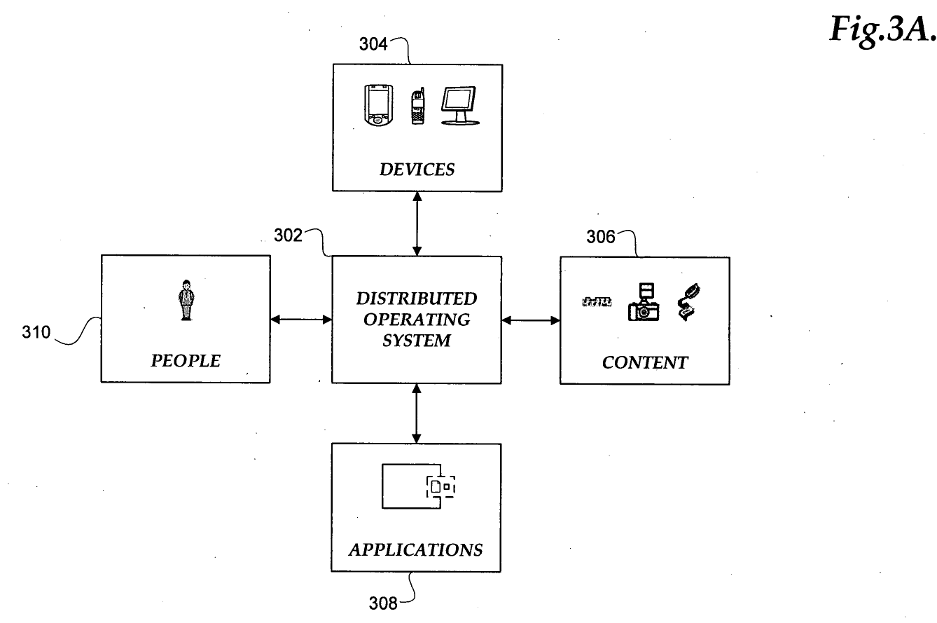

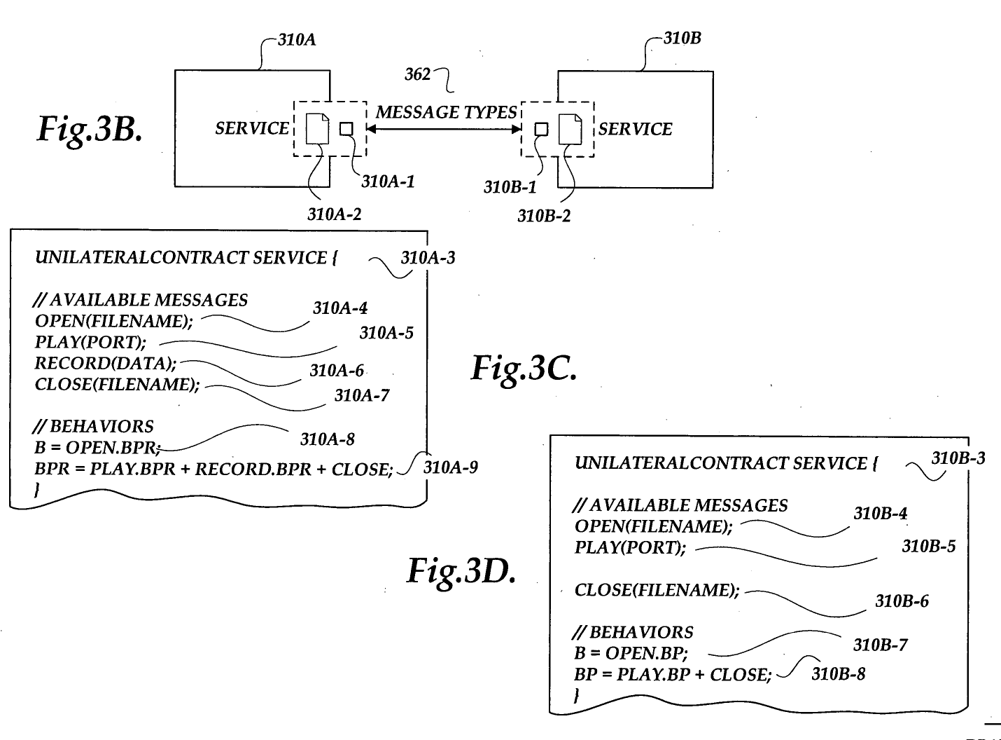

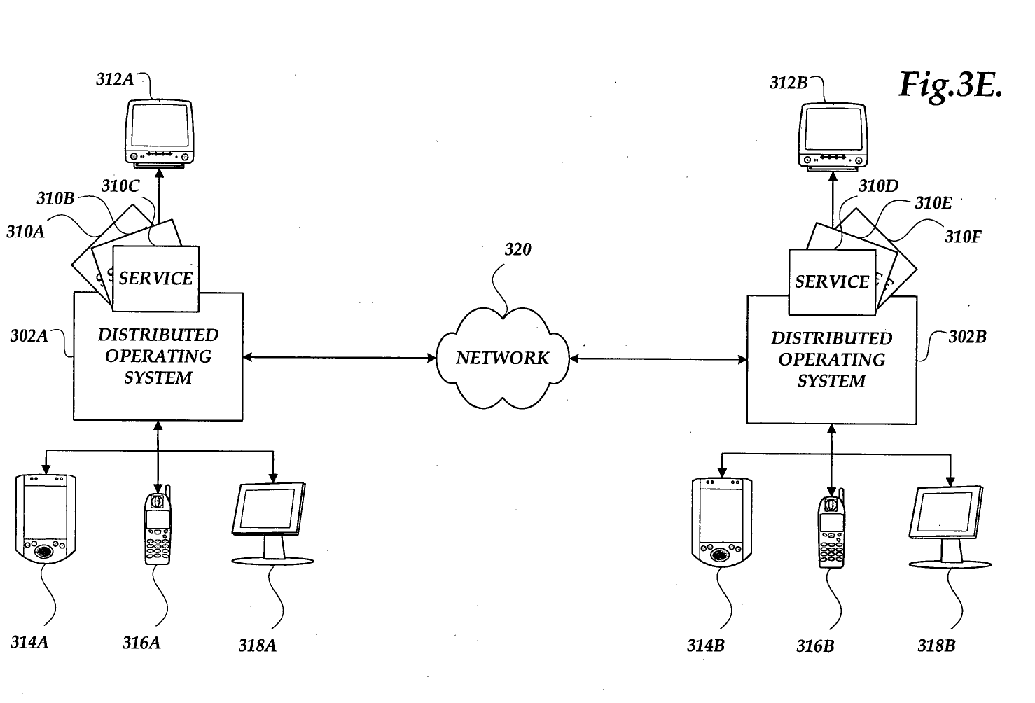

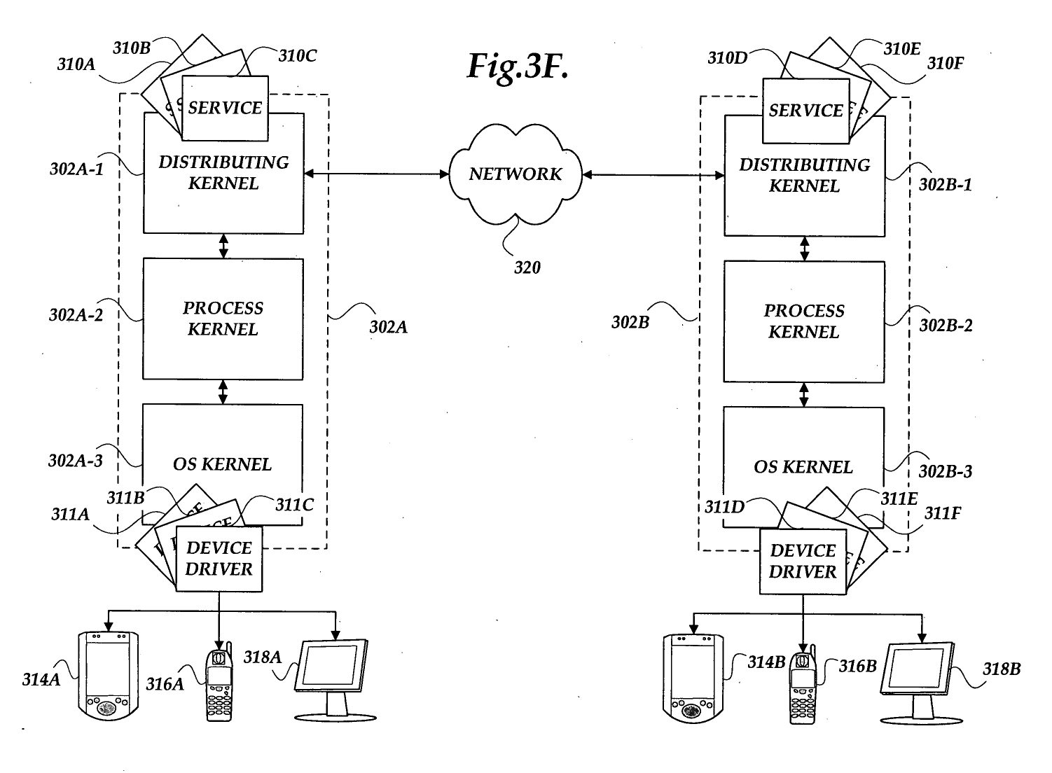

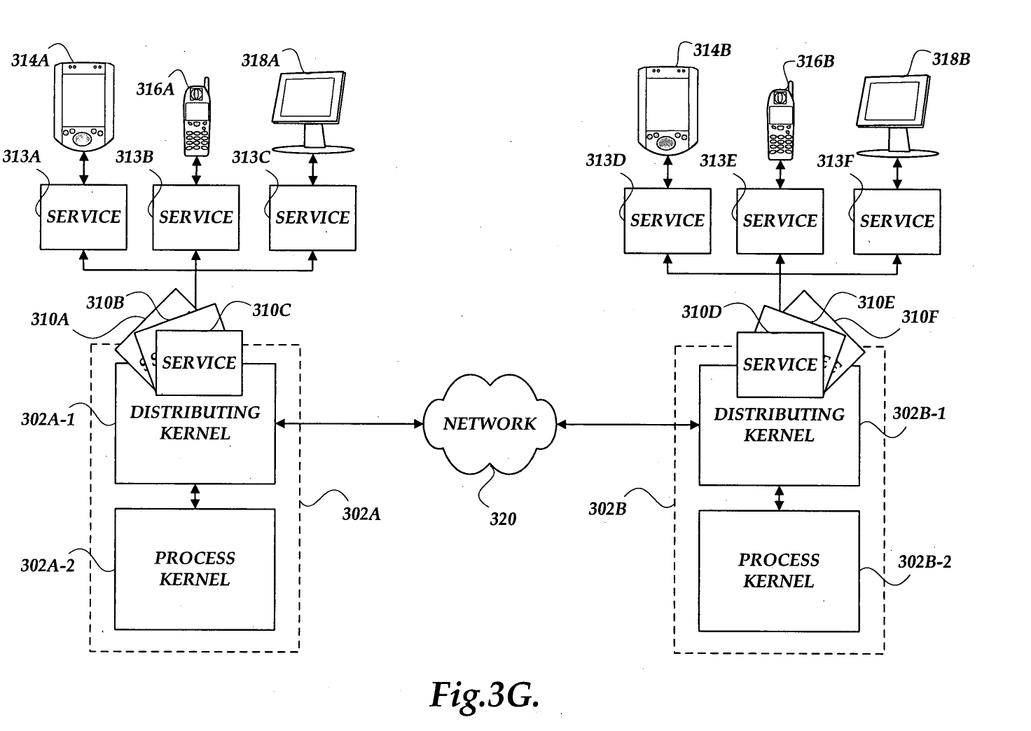

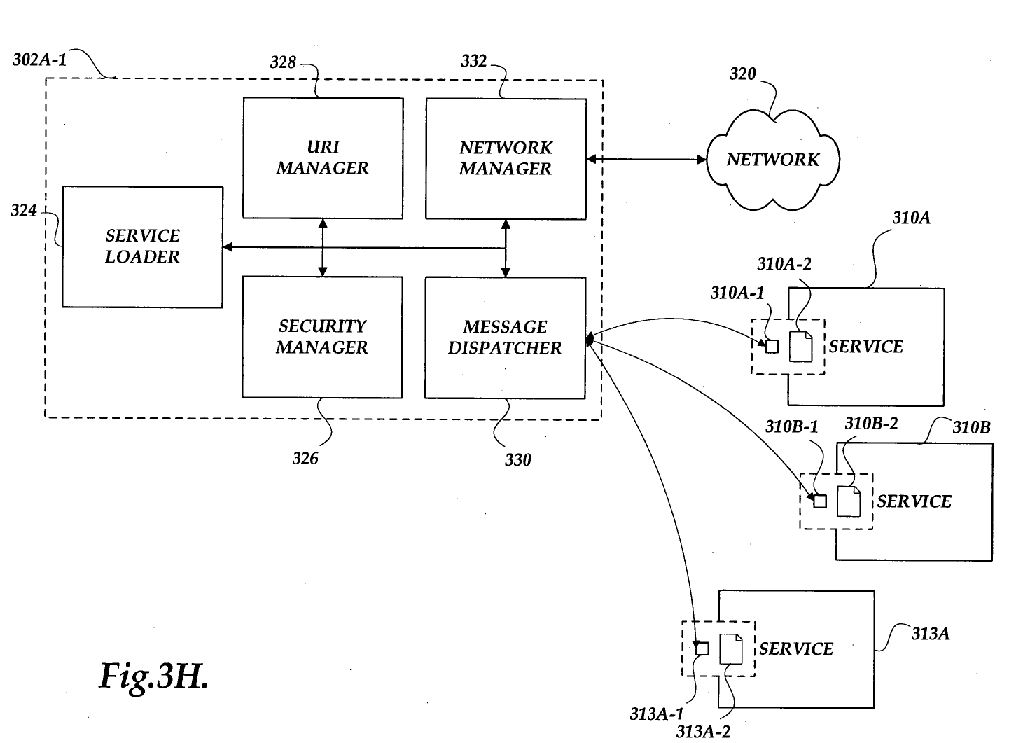

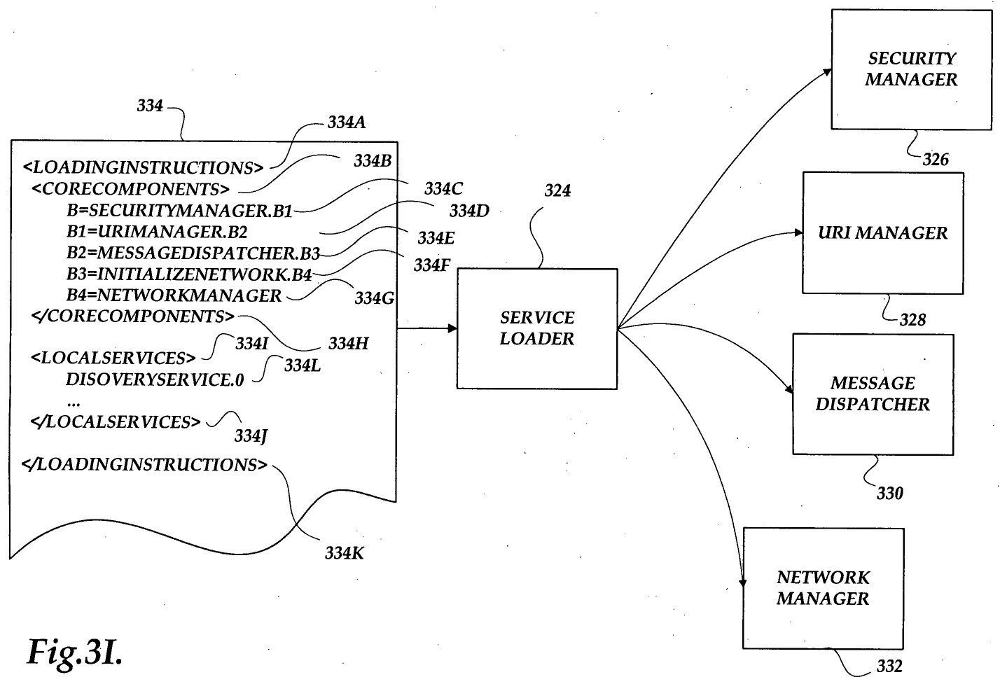

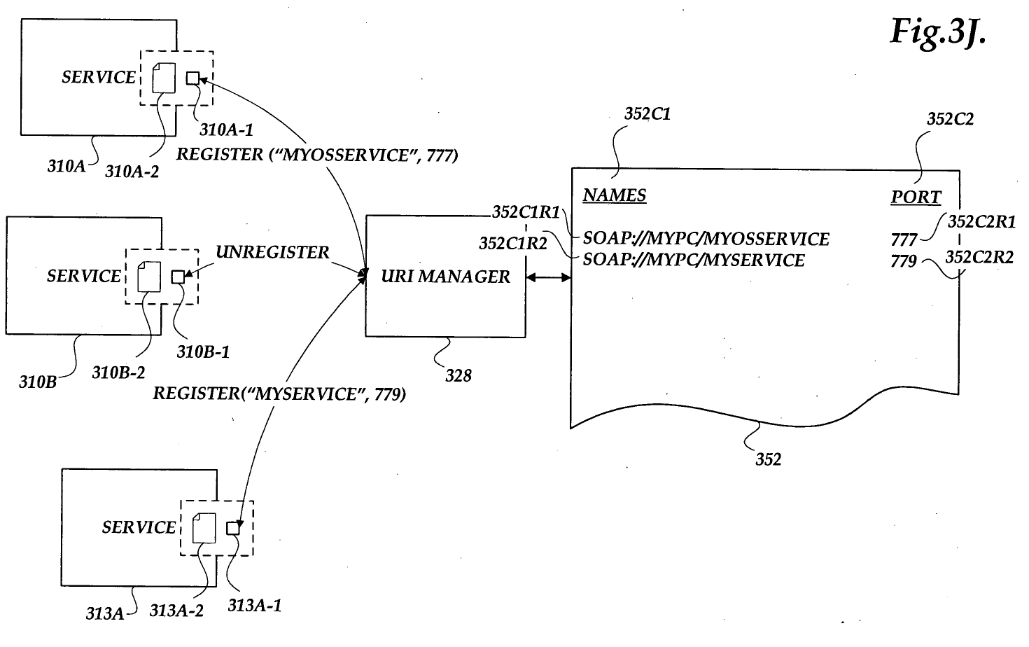

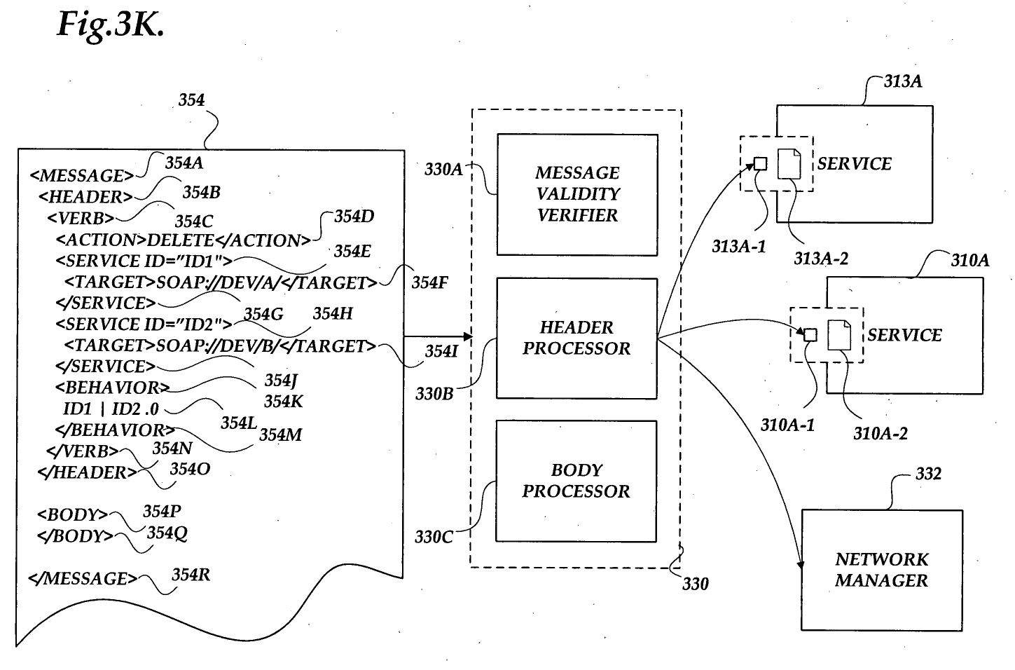

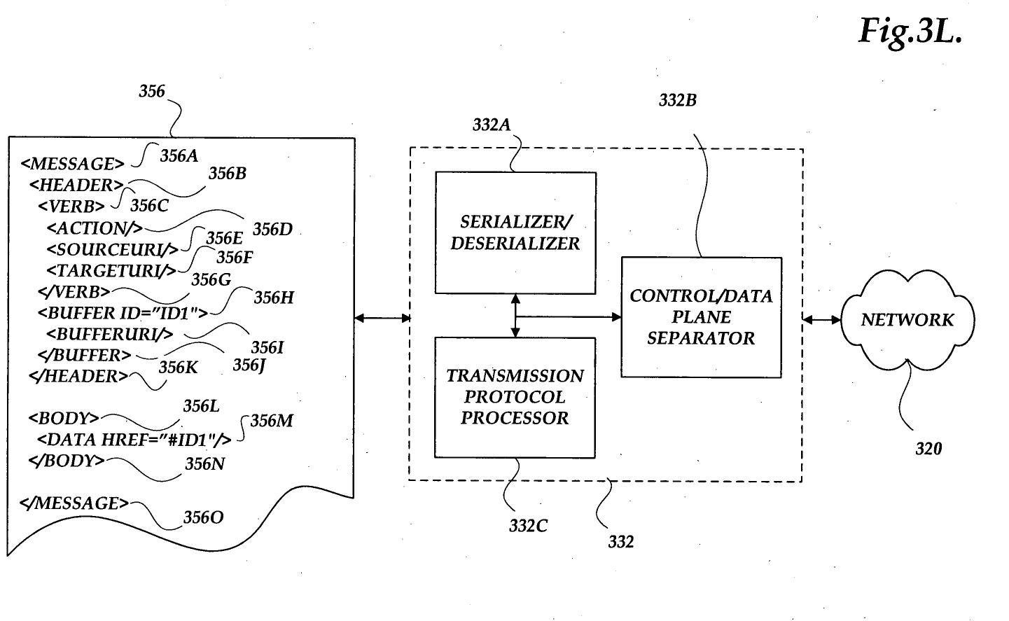

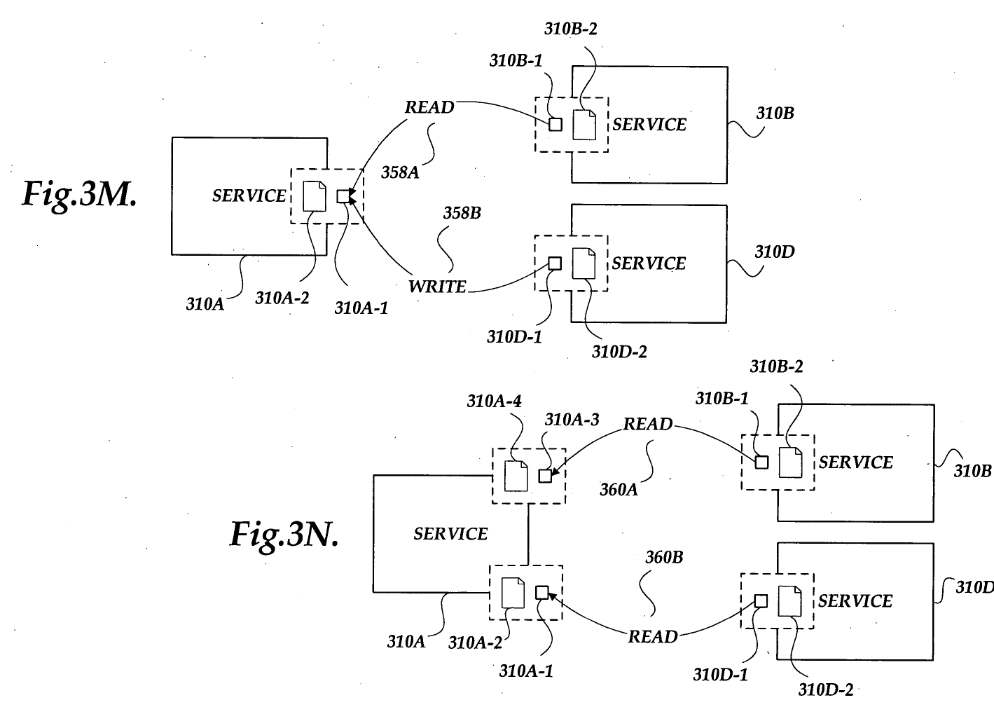

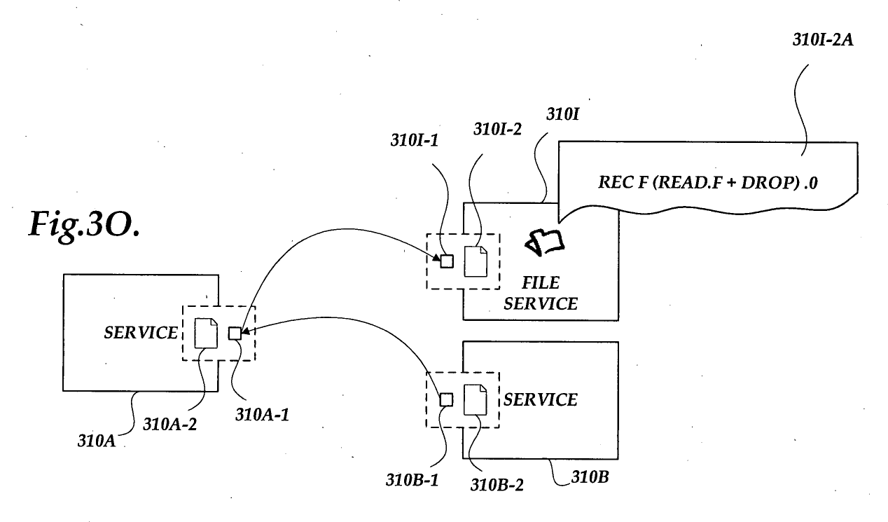

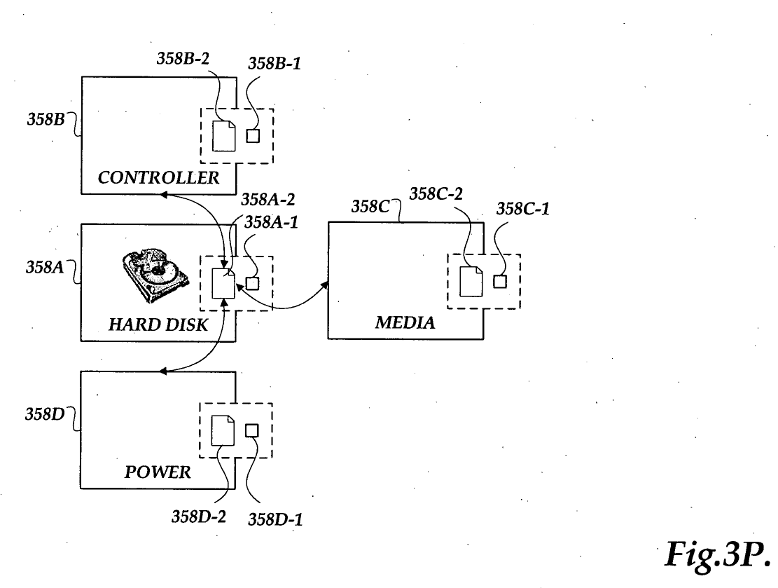

A decentralized operating system 302 is illustrated in FIG. 3A. The decentralized operating system participates in a noncentralized network consisting of numerous computer systems that can communicate with one another and that appear to users as parts of a single, large, accessible “storehouse” of shared hardware, software, and data, which are all preferably represented as services. The decentralized operating system 302 is conceptually the opposite of a centralized, or monolithic, operating system in which clients connect to a single central computer, such as a mainframe. The power of control and coordination of the decentralized operating system 302 comes not from being at one place at one time but instead comes from being capable of composing services, local or remote, and form applications that are desired by users.

The decentralized operating system 302 creates unity from multiplicity. The multiplicity includes devices 304, which include any piece of equipment or mechanism designed to serve a special purpose or perform a special function, such as a personal digital assistant, a cellular phone, or a monitor display, among others. The multiplicity also includes any piece of content 306, such as sound, graphics, animation, video, or other pieces of data or information. The multiplicity further includes applications 308, which are programs designed to assist in the performance of a specific task, such as word processing, accounting, or inventory management. Applications 308 are compositions of one or more services. The multiplicity yet further includes people 310. The people 310 are those individuals wishing to gain access to the decentralized operating system 302 to use resources, such as devices 304, pieces of content 306, and applications 308. The multiplicity also includes rights, restrictions, or both, on various permutations of devices 304, content 306, applications 308, and people 310. Unity is created when pieces of the multiplicity is represented as services as described below.

Devices 304, content 306, applications 308, and people 310 can be abstracted as autonomous computation entities called services that exchange messages according to protocols, which are defined by each service. Services are small entities with well-defined boundaries. Each service executes in its own execution context and not necessarily of an execution context belonging to an external calling service. Services can be local to a computer system but can also be located at a remote computer system. Services can be accessed through a single trust domain but can also be accessed through another trust domain with its own security policy. Services can be discoverable through a directory service but can also be discovered by services that are not directory services.

The decentralized operating system 302 can unify devices 304, content 306, applications 308, and people 310, as well as combinations of their rights and restrictions, because each of them can be represented as services to create a computing environment for composing other services, and allows the discovery of services and the composition of services. Devices 304, content 306, applications 308, and people 310, as well as combinations of their rights and restrictions, are loosely coupled to the decentralized operating system 302. Yet, the decentralized operating system 302 can compose, arrange, or combine various pieces of the multiplicity. Each piece of the multiplicity 304-310 need not be known a priori by the decentralized operating system 302, but each piece is preferably discoverable so that the decentralized operating system 302 can compose, arrange, or combine to create the desired functionality. This unifying effect of the decentralized operating system 302 allows every piece in the multiplicity to know how to communicate to every other one regardless of how diverse one piece of the multiplicity might be. Because devices 304, content 306, applications 308, and people 310, as well as combinations of their rights and restrictions, can be unified, each of them can be located locally or dispersed remotely and yet all of them can communicate with one another.

FIG. 3B illustrates two services 310A, 310B, each with a port identifiable by an identifier that includes a uniform resource identifier (URI) 310A-1, 310B-1, which constitutes a unique designation of a service, such as an operating system service, and a unilateral contract 310A-2, 310B-2. Several primitives form the minute essence of various embodiments of the present invention: a designation primitive, which comprises a port, such as the ports identifiable by the URI, 310A-1, 310B-1; a behavioral primitive, which comprises the unilateral contract, such as unilateral contracts 310A-2, 310B-2; an organizational primitive, which comprises a service, such as services 310A, 310B; and a communication primitive, which includes a set of message types 362 known by all services, that separates the data plane from the control plane for facilitating communication of control information and data information. The term “message type” means the inclusion of commanding, instructing, ordering, calling, controlling, requesting, or managing a service to perform a certain task. Permutations in the invocation order of various members of the set of message types 362 are essentially protocols for expressing behaviors for services running on a decentralized operating system.

These primitives are capable of being applied at various levels, such as a retrogression to a less complex level of organization or a progression to a more complex level of organization: at a file containing a piece of content 306; at a device among devices 304, which can be either internal or external to a computer system; at an application among applications 308; at a computer system; across a home or an office; across an entire neighborhood or multiple offices of an organization; and across the entire world. This retrogression and progression is made possible by the use of a combination of these primitives everywhere.

Devices 304, content 306, applications 308, or people 310 can be represented as services, and as services they all can be unified by the decentralized operating system 302 even though each of them is diverse from the others. Ports of services are endued with behavioral types, which are specified by the unilateral contracts. The preferred communication mechanism of the decentralized operating system 302 is through programmatically wired ports. Wired ports are possible if the behavior type of one port (of a service) is compatible with the behavior type of another port (of another service). When ports are programmatically wired to each other, which are identifiable by URIs 310A-1, 310B1, services 310A, 310B communicate by sending messages to each other. Simply put, unilateral contracts 310A-2, 310B-2 are expressed in a language specifying an order of messages which flow in or out of services 310A, 310B. By the use of messages, heterogeneous resources distributed in multiple trust domains, each with its own security policy, can communicate with one another.

Sharing of resources is possible through interaction in a compatible way with the behaviors of the resources. Behaviors of resources (represented by services) are expressed in unilateral contracts. For example, a file as a service can exposed its behaviors through unilateral contracts. A service can be regulated by a unilateral contract. Thus, one can attach behavioral conditions to files via unilateral contracts to govern access control. A read-only file should behave quite differently from a file available for both reading and writing. It is preferred to represent each file type through separate unilateral contracts. A read-only file unilateral contract may include the following behavioral expression: REC F (read.F+drop).0, whereas a read-write file's unilateral contract has the following behavioral expression: REC F (read.F+write.F+drop).0. In parsing the behavioral expressions, the term REC F indicates a recursion on a behavior phrase F; the behavior phrase F indicates the behavior expressions inside the pairs of parentheses; the message type “read” indicates a read operation; the period symbol “.” denotes a sequence in which the behavior phrase before the period symbol occurs and after which the behavior phrase following the period symbol will then occur; the plus sign symbol “+” indicates a choice between one or more behavior phrases; the message type “write” indicates a write operation; the message type “drop” indicates the termination of the communication between two services; and the zero symbol “0” denotes the termination of the behavior expression.

A portion of the unilateral contract 310A-2 is illustrated in FIG. 3C. Line 310A-3 contains the key word UNILATERALCONTRACT followed by the designator “SERVICE,” and a pair of open and closed curly brackets “{ }” for delimiting the definition of the unilateral contract 310A-2. Line 310A-4 declares the signature of the OPEN operation that takes a file name “FILENAME” as a parameter. To use the service 310A, external services specify a name of a file to be opened via the OPEN operation. Thus, the OPEN operation should be the first operation that is invoked by other services for each session. The PLAY operation is declared on line 310A-5. The PLAY operation takes another service's port as a parameter. When the PLAY operation is invoked by other services, the service 310A reads a stream of data from an open file and transmits the read data toward the given service's port. Other services, such as the service 310B, can also record information to opened files via the RECORD operation, which is declared on line 310A-6. The RECORD operation takes data as a parameter. This data is written by the RECORD operation to the opened file. When all desired operations have been carried out on the opened file, the opened file can be closed via the CLOSE operation, which is declared on line 310A-7. The CLOSE operation takes a file name “FILENAME” as an argument so that the CLOSE operation knows which file to close.

Lines 310A-8-310A-9 contain the behaviors of the service 310A. Line 310A-8 contains a behavior sentence: B=OPEN.BPR, where B is a behavior rule; OPEN denotes that the OPEN operation is the first operation to be invoked in using the service 310A; the period “.” denotes that additional behaviors are to follow the invocation of the OPEN operation; BPR refers to a second behavior sentence defined further on line 310A-9. Line 310A-9 contains the following behavioral sentence: BPR=PLAY.BPR+RECORD.BPR+CLOSE, where BPR denotes the second behavior; PLAY.BPR denotes the invocation of the PLAY operation, which is then followed by the second behavior again (a recursion); RECORD.BPR denotes the invocation of the RECORD operation, which is then followed, recursively, by the second behavior; CLOSE denotes the invocation of the CLOSE operation; and the plus signs “+” denote choices that other services, such as the service 310B, can make to invoke among the PLAY operation, the RECORD operation, or the CLOSE operation.

A portion of the unilateral contract 310B-2 is illustrated in FIG. 3D. Line 310B-3 contains the keyword UNILATERALCONTRACT followed by the designator “SERVICE,” and a pair of open and closed curly brackets “{ }” for delimiting the definition of the portion of the unilateral contract 310B-2. Line 310B-4 declares the signature of the OPEN operation that takes a file name “FILENAME” as a parameter. The PLAY operation is declared on line 310B-5. The PLAY operation takes another service's port as a parameter. The CLOSE operation is declared on line 310B-6 and it takes a filename “FILENAME” as an argument so that the CLOSE operation knows which file to close.

Lines 310B-7-310B-8 contain the behaviors of the service 310B. Line 310B-7 contains a behavior sentence: B=OPEN.BP, where B is a behavior rule; OPEN denotes that the OPEN operation is the first operation to be invoked in a session with the service 310B; the period “.” denotes that the additional behaviors are to follow the invocation of the OPEN operation; and BP refers to a second behavior sentence defined further on line 310B-8. Line 310B-8 contains the following behavioral sentence: BP=PLAY.BP+CLOSE, where BP denotes the second behavior; PLAY.BP denotes the invocation of the PLAY operation, which is then followed by the second behavior again (a recursion); CLOSE denotes the invocation of the CLOSE operation; and the plus sign “+” denotes choices that an external service, such as the service 310A, can make to invoke among the PLAY operation and the CLOSE operation.

The unilateral contract 310A-2, when accepted by the service 310B, and the unilateral contract 310B-2, when accepted by the service 310A, creates an instance of communication between the service 310A and the service 310B. Each unilateral contract 310A-2, 310B-2 can be accepted by the services 310A, 310B by a mere promise to perform, but also by the performance of unilateral contracts 310A-2, 310B-2 in accordance with the behaviors expressed in those unilateral contracts. Thus, if the service 310B complies with and performs the behaviors as expressed by behavior sentences 310A-8, 310A-9 of the unilateral contract 310A-2, the service 310B is bound to provide the promised services. For example, if the service 310B has performed by first invoking the OPEN operation as specified by the behavioral sentence 310A-8 and then either invoking the PLAY operation or the RECORD operation or the CLOSE operation as specified by the behavioral sentence shown on line 310A-9, then the service 310A complies with the requested invocations to provide the desired services, such as opening a file, playing the content of the file, recording content into a file, or closing the file.

FIG. 3E illustrates decentralized operating systems 302A, 302B, executing on personal computers 312A, 312B. A personal computer is a computer designed for use by one person at a time and need not share the processing, disk, and printer resources of another computer. The decentralized operating system 302A orchestrates the interoperation of a number of services 310A-310C and a computing device, such as a personal digital assistant 314A; a telecommunication device, such as a cellular telephone 316A; or a display device, such as a flat-screen monitor 318A. The decentralized operating system 302B can also orchestrate the interoperation of a number of services 310D-310F and a number of devices, including a computing device, such as a personal digital assistant 314B; a telecommunication device, such as a cellular telephone 316B; or a display device, such as a flat screen monitor 318B.

The decentralized operating system 302A, services 310A-310C, and devices 314A-318A can communicate and interoperate with the decentralized operating system 302B, services 310D-310F, and devices 314B-318B via a network 320. The network 320 includes a group of computers and associated devices that are connected by communication facilities. The network 320 can involve permanent connections, such as coaxial or other cables, or temporary connections made through telephone or other communication links, such as wireless links. The network 320 can be as small as a LAN (Local Area Network) consisting of a few computers, printers, and other such devices, or it can consist of many small and large computers distributed over a vast geographic area (a WAN or wide area network). One exemplary implementation of a WAN is the Internet, which is a worldwide collection of networks and gateways that use the TCP/IP suite of protocols to communicate with one another. At the heart of the Internet is the backbone of high-speed data communication lines between major nodes or host computers, including thousands of commercial, government, educational, and other computer systems that route data by messages.

These messages not only allow services 310A-310C coupled to the decentralized operating system 302A to communicate with each other, but these messages also facilitate communication with services 310D-310F coupled to the decentralized operating system 302B. Either the decentralized operating system 302A or the decentralized operating system 302B can be viewed as a collection of services that compute within a scope. The scope is defined not by the physical structure of the computer system, such as personal computer 312A, 312B, but by the services whose composition defines a security boundary within one or across multiple trust domains.

Decentralized operating systems 302A, 302B enable communication across trust domains. Each decentralized operating system 302A, 302B supports deployment and use of services 310A-310F across boundaries of different trust domains. The decentralized operating system 302A, 302B, assumes that trust domains are virtual and does not assume that physical proximity implies any level of trust between communicating services 310A-310F. Each decentralized operating system 302A, 302B orchestrates services or other services that cannot be anticipated to be within physical proximity. Various environments in which the decentralized operating system 302A, 302B can be deployed include high bandwidth, low latency systems such as LANs; high bandwidth, high latency systems, such as WANs; low bandwidth, high latency systems, such as dial-up connections and wireless connections; and low bandwidth, low latency systems, such as exchanged electronic business cards. Although each decentralized operating system 302A, 302B need not have access to the network 320, its functionality is enhanced when the decentralized operating system 302A, 302B is connected to the network 320.

In various embodiments of the present invention as shown at FIG. 3F, the decentralized operating systems 302A, 302B include an operating system kernel 302A-3, 302B-3; a process kernel 302A-2, 302B-2; and a distributing kernel 302A-1, 302B-1. Whereas the distributing kernels 302A-1, 302B-1 preferably focus on the distribution of computation, the operating system kernels 302A-3, 302B-3 are preferably used to manage resources within the decentralized operating systems 302A-302B. The processed kernels 302A-2, 302B-2 are preferably responsible for scheduling processes.

Operating system kernels 302A-3, 302B-3 are each a portion of the decentralized operating systems 302A, 302B that manage memory; control peripheral devices; maintain the time and date; allocate system resources; and so on. In order for operating system kernels 302A-3, 302B-3 to communicate with devices 314A-B, 316A-B, and 318A-B, a number of device drivers 311A-311F are used. In various cases, each device driver 311A-311F also manipulates the hardware in order to transmit the data to devices 314A-B, 316A-B, and 318A-B.

The process kernels 302A-2, 302B-2 are pieces of software that represent services 310A-310F among other services as processes, manage these processes, and facilitate the communication of one process with other processes. One exemplary implementation of a process kernel is as described in U.S. patent application Ser. No. 10/303,407, titled “Process Kernel,” filed Nov. 22, 2002. The process kernels 302A-2, 302B-2 can model various pieces of software in the operating system kernels 302A-3, 302B-3 as services, which cause these pieces of software to be loosely coupled, asynchronous services. One exemplary application of a decentralized operating system, such as the decentralized operating systems 302A, 302B, is a Web service platform capable of hosting a large number of concurrent, loosely coupled, message-based Web services. Another application of a decentralized operating system, such as the decentralized operating systems 302A, 302B, is an infrastructure for facilitating decentralization of a centralized operating system, such as the Linux operating system. A decentralized operating system, such as the decentralized operating systems 302A, 302B, is a generic infrastructure for distributing services.

The distributing kernels 302A-1, 302B-1 are pieces of software in which computation processing is performed by separate services on one computer or spread among multiple computers linked through a communications network, such as the network 320. Each service coupled to the distributing kernels 302A-1, 302B-1 can perform different tasks in such a way that their combined work in a composition has a total computing effect greater than each alone. Distributing kernels 302A-1, 302B-1 allow hardware, such as devices 314A-B, 316A-B, and 318A-B, and services 310A-310F, among other services and software to communicate, share resources, and exchange information freely, as long as each performs in accordance with a unilateral contract of a service, which is the target of the communication.

In various other embodiments of the present invention as shown at FIG. 3G, the decentralized operating systems 302A, 302B include a process kernel 302A-2, 302B-2 and a distributing kernel 302A-1, 302B-1 but lack an operating system kernel 302A-3, 302B-3. The decentralized operating systems 302A, 302B, in this embodiment, have transformed various pieces of software in the operating system kernels 302A-3, 302B-3 into multiple services 310A-310F. Therefore, the two blocks that represent the operating system kernels 302A-3, 302B-3 are no longer illustrated in FIG. 3G. Device drivers 311A-311F have also been transformed into services 313A-313F, which are managed by the distributing kernel 302A-1 or the distributing kernel 302B-1. Devices 314A-B, 316A-B, and 318A-B are represented as services accessible as if they were like any services 310A-310F on either the distributing kernel 302A-1 or the distributing kernel 302B-1 across the network 320.

A resource in various embodiments of the present invention can be described by some data types defining the resource's structure (preferably using a customizable, tag-based language, such as extensible markup language [XML] schema) and some behavioral types defining its communication patterns (unilateral contracts). Data in the context of the decentralized operating systems 302A, 302B is preferably associated with behaviors. Many portions of code associated with the operating system kernel 302A-3, 302B-3, such as device drivers 311A-311F, can be represented as services 313A-313F. Devices 314A-B, 316A-B, and 318A-B offer services, and so it is natural to represent devices as services. Whereas the Linux operating system represents devices among other resources as files, the decentralized operating system of the various embodiments of the present invention model devices as services. Services communicate with other services via passing messages.

A distributing kernel, such as the distributing kernel 302A-1, is illustrated in greater detail at FIG. 3H. The distributing kernel 302A-1 includes a service loader 324, a security manager 326, a URI manager 328, a message dispatcher 330, and a network manager 332. The service loader 324 is a component that loads other components of the distributing kernel 302A-1 or other services into memory for execution. The security manager 326 protects the distributing kernel 302A-1 from harm by aberrant services or unauthorized messages sent by services. The URI manager 328 manages names, each constituting the distinctive designation of a service so that it can be discovered. The message dispatcher 330 sends messages among communicating services, such as services 310A, 310B, and a service 313A. Like services 310A, 310B, the service 313A has a port identifiable by an identifier that includes a URI 313A-1 and a unilateral contract 313A-2. Each port is associated with a URI 310A-1, 310B-1, and 313A-1 allowing the message dispatcher 330 to know to whom to send messages. When one of the local services, such as services 310A, 310B and the service 313A need to communicate with another service across the network 320, the network manager 332 is employed. The network manager 332 is capable of separating a message into a control plane on which the message type of the message and data references (if any) are sent and a data plane on which data referenced by the control plane is transferred. Preferably, the data is sent directly to the memory of a remote computer system using a suitable technique.

When a service is loaded, it registers with the URI manager 328. That allows the service to send and receive messages from other services regardless of whether these services are local or remote. When the service registers with the URI manager 328, the security manager 326 is consulted to verify that the service has sufficient right to request for a URI. If the security manager 326 approves the request, then the URI manager 328 proceeds to register the service. A URI is produced for the service, and the service is hooked up to the message dispatcher 330 so that it can send and receive messages.

Services running on a computing system define a scope. Such a computing system includes personal computers 312A-B, personal digital assistants 314A-B, cellular phones 316A-B, flat monitors 318A-B, and so on. The scope is enforced by creating an initial number of trusted components and services, such as the service loader 324, the security manager 326, the URI manager 328, the message dispatcher 330, and the network manager 332, that communicate with one another. These components exchange messages on a common channel. The network manager 332 makes communication with other computing systems possible. A discovery service (not shown) attempts to enumerate devices or services that are coupled to the computing system on which the distributing kernel 302A-1 executes. A device driver or a dynamically linked library can be represented as a service and be loaded from a local storage medium or enumerated from a remote computer system coupled to the network 320. If a service was loaded locally, it executes locally, but it is addressed as if it were a service running on a remote computer system.

During a boot up sequence to initialize the decentralized operating system 302A, the service loader 324 executes a sequence of instructions, such as a portion 334. See FIG. 3I. The portion 334 captures the initial set of components and services to load during a boot up sequence. The portion 334 is preferably written in a customizable, tag-based language, such as extensible mark-up language (XML), which can be consumed or understood by the service loader 324. The service loader 324 can also be used to dynamically load or unload services during operation of the decentralized operating system 302A.

A portion of the loading instructions 334 includes a root tag <LOADINGINSTRUCTIONS> 334A and its companion ending tag </LOADINGINSTRUCTIONS> 334K. Contained between the tags 334A, 334K is a tag <CORECOMPONENTS> 334B and its ending tag </CORECOMPONENTS> 334H. Contained between tags 334B, 334H are a number of instructions written in a process language. Enclosed between tags 334B, 334H is a behavioral sentence 334C: B=SECURITYMANAGER.B1, where B defines a behavioral sentence B; and the equal sign “=” denotes that a definition of the behavioral sentence B is to follow. The term “SECURITYMANAGER” indicates an instantiation of the security manager 326; the period symbol “.” denotes that after the instantiation or invocation of the security manager 326 another process will follow; and the term B1 indicates another behavioral sentence B1 to be executed following the instantiation of the security manager 326. Line 334D defines another behavioral sentence B1: B1=URIMANAGER.B2, where B1 is a designation for a behavioral sentence B1; the equal sign “=” denotes that a definition of the behavioral sentence B1 is to follow; and the term URIMANAGER.B2 indicates that an instantiation of the URI manager 328 occurs prior to the execution of a behavioral sentence B2. The behavioral sentence B2 is defined on line 334E as follows: B2=MESSAGEDISPATCHER.B3, where the term B2 designates the behavioral sentence B2; the equal sign “=” denotes that a definition of the behavioral sentence B2 is to commence; the term MESSAGEDISPATCHER.B3 indicates that the service loader 324 instantiates the message dispatcher 330, and then the service loader 324 executes a behavioral sentence B3. Line 334F contains a definition of the behavioral sentence B3: B3=INITIALIZENETWORK.B4, where the term B3 is a designation for the behavioral sentence B3; the equal sign “=” heralds the beginning of the definition for the behavioral sentence B3; and the term INITIALIZENETWORK.B4 indicates that various network parameters and hardware are initialized, which is then followed by the execution of a behavioral sentence B4. The network manager 332 is instantiated by the service loader 324 at line 334G after which the instantiation of the core components terminates. In other embodiments, the core components are not loaded by the service loader 324 but instead are part of the runtime environment at start up.

Between tags 334A, 334K is a tag <LOCALSERVICES> 334I and its companion-ending tag </LOCALSERVICES> 334J. Tags 334I, 334J contain services that are to be invoked or instantiated at the initialization of the decentralized operating system 302A. One service to be instantiated is a discovery service designated in the portion 334 as DISCOVERYSERVICE for enumerating devices and services. An ellipsis “ . . . ” denotes that further service loading instructions can be provided between tags 334I, 334J.

The service loader 324 is responsible for ensuring that local services (as defined between tags 334I, 334J) are registered with the URI manager 328 so that they can be used by other services whether these services are local or remote. As more and more services are loaded, the functionality provided by a computer system at which a decentralized operating system (such as the decentralized operating system 302A) resides becomes richer and more populous. The service loader 324 can be used to provide general or specific functionality for a computer system or a node at which a decentralized operating system resides. The term “nodes” means the inclusion of a computer system, such as personal computers 312A-B, devices 314A-B, 316A-B, and 318A-B, and any piece of machinery that has a microprocessor, that is connected to the network 320.

FIG. 3J illustrates the URI manager 328 in greater detail. In order for a service to communicate with other services and be orchestrated by the decentralized operating system 302A, the service registers itself with the URI manager 328 to obtain a URI (a unique name). As no individual service a priori knows names of other services on a particular decentralized operating system, the URI manager 328 is used to create names thereby avoiding naming conflicts. A registry 352 is maintained by the URI manager 328 and is a list of two columns and multiple rows. Column 352C1 represents a list of unique names. Column 352C2 is a list of port numbers. Each port number is a number that enables IP packets to be sent to a computer system connected to the network 320. Together, the information from columns 352C1, 352C2 on a particular row forms a URI.

For example, the service 310A sends a REGISTER message to the URI manager 328 with a preferred name “MYOSSERVICE” and a port “777” at which it receives messages. In response to the REGISTER message sent by the service 310A, the URI manager 328 checks with the security manager 326 to make sure that the service 310A has the authorization to register. If the service 310A has proper authorization, the URI manager 328 creates a URI 310A-1 which is descriptively expressed as “SOAP://MYPC/MYOSSERVICE:777”. See cells 352C1R1, 352C2R1. The URI 310A-1 is a concatenation of the text shown at the cell 352C1R1 and the port number shown at cell 352C2R1.

A service can act so that it is unregistered with the URI manager 328. When a service has unregistered, its URI is removed from the registry 352. An unregistered service cannot be discovered by other services wanting to communicate with it. To unregister, a service sends an UNREGISTER message to the URI manager 328. The URI manager 328 checks with the security manager 326 to make sure that the service 310A has the authorization to unregister. If the service 310A has proper authorization, the URI manager 328 removes the URI from the registry 352. See, for example, the service 310B sending an UNREGISTER message to the URI manager 328 to remove its URI from the registry 352.

A service, such as an operating system service, can also register itself with the URI manager 328. The service 313A sends a REGISTER message with its preferred name “MYSERVICE” and the port “779” at which it receives messages. The URI manager 328 checks with the security manager 326 to make sure that the service 313A has the authorization to register. If the service 313A has proper authorization, the URI manager 328 creates a new URI 313A-1 for the service 313A as “SOAP://MYPC//MYSERVICE:779”. See cell 352C1R2. The URI 313A-1 is a concatenation of both the descriptive text in the cell 352C1R2 and the port number 779 in cell 352C2R2.

Each URI managed by the URI manager 328 identifies a portal through which to reach a service. Each URI is unique in the registry 352. Preferably, each URI is styled using the domain name system (DNS). DNS names consist of a top-level domain, a second-level domain, and possibly one or more subdomains. Services can register not only for URIs, but also URI prefixes, hence enabling services to manage their own name space. For example, a service can register for the name space /MYSERVICE/*. This registration means that all URIs matching that prefix will be dispatched to that service. If resources, such as devices, use a global user identifier (GUID), it is preferred for this GUID be made part of the <servicepath> phrase. For example, suppose that a GUID for a service is “257B3C60-7618-11D2-9C51-00AA0051DF76”. An exemplary URI containing the GUID includes “devices/hdd/257B3C60-7618-11D2-9C51-00AA0051DF76” in which the phrase “devices/hdd/” is a prefix automatically inserted by the URI manager 328.

As used in various embodiments of the present invention, no semantics and no hierarchical meanings are associated with URIs assigned by the URI manager 328 to various services. An exemplary URI includes “SOAP://MYPC.MYOSSERVICE/:777”. The term “no semantics” means that one cannot get rid of any part of the URI and traverse a hierarchy. Additionally, no containment meanings are attached to each URI. Thus, removing a name of the URI does not necessarily mean that services subsequent to the deleted name will be removed from the system.

It is preferable to keep the association between a service and its URI persistent throughout the lifetime of the service. This allows other services to rely on URIs that have been publicly exposed so that these services can be assured that communication will not break because of URI changes. For example, it is preferable not to change a URI as a result of a reboot of a decentralized operating system.

For any service to talk to another service, it is preferable not only for the service to have a URI of the other service but that it have a URI identifying itself to the other service. For example, when the service 310A sends the service 310B a request, the service 310B responds with an acknowledgment message. The acknowledgment message is not necessarily a full response—that comes later. When the service 310B has processed the request and sends a response, the port 310A-1 of the service 310A given to the service 310B allows the service 310B to know where to return the response. Suppose that the service 310A moves to the computer system on which the decentralized operating system 302B resides from the computer system on which the decentralized operating system 302A resides. The port identifiable by the URI 310B-1 moves with the service 310B allowing it to continue to receive messages from the service 310B.

When a service, such as the service 313A or the service 310A, has registered and obtained a URI, such as URIs 313A-1, 310A-1, the URI manager 328 hands these URIs to the message dispatcher 330. See FIG. 3K. The message dispatcher 330 includes a message validity verifier 330A, a header processor 330B, and a body processor 330C. The message validity verifier 330A processes each message to determine whether a message is in a proper format for processing. If the message is not in the proper format, the message validity verifier 330A rejects the message and refrains from forwarding the message to other services.

Each message is preferably written in XML in a format that complies with a suitable protocol for exchanging structured and type information among services. One suitable protocol includes the Simple Object Access Protocol (SOAP), but other suitable protocols can be used. The message dispatcher 330 preferably knows how to process SOAP compliance messages. The essence of the message dispatcher 330 is passing messages from one local service to another local service, as well as passing incoming messages from the network manager 332 to a local service and outgoing messages from local services to the network manager. The foundation of the message dispatcher 330 is based on the following: a service is a resource identified by a URI; a service can generate messages and send them to other services; and a service can accept messages sent from other services.

SOAP compliance messages have a header and a body. The header processor 330B of the message dispatcher 330 processes the header of a message. The header processor 330B processes headers of messages in order to determine which service should receive the message. The header also includes from whom the message was sent and to whom the message should be sent. If the message is for a local service, the message dispatcher forwards the message to the local service. Otherwise, if the message is for a service located at a remote node, the message dispatcher forwards the message to the network manager 332 for sending the message over the network 320. The body processor 330C of the message dispatcher 330 processes the body of the message.

An exemplary message 354 includes a root tag <MESSAGE> 354A and its companion ending tag </MESSAGE> 354R. The tags 354A, 354R define the beginning and end of a message processed by the message dispatcher 330. Messages generally have two sections, a header section and a body section, as discussed above. A tag <HEADER> 354B and its companion ending tag <HEADER> 3540 define the section heading of a message. A tag <BODY> 354P and its companion ending tag </BODY> 354Q define the body section of a message. A tag <VERB> 354C and its companion ending tag </VERB> 354N contain actions required from one or more target services. Line 354D declares a DELETE action defined between an <ACTION> tag and its companion ending tag </ACTION>. A tag <SERVICE> 354E and its companion ending tag </SERVICE> 354G define a target service for receiving the action via its URI. The tag 354E includes an attribute ID=“ID1”, which is used to textually describe the URI of a target service expressed between tags 354E, 354G at line 354F. A tag <TARGET> and its companion ending tag </TARGET> define a URI “SOAP://DEV/A/”. The URI of another target service is defined between a tag <SERVICE> 354H and its companion ending tag </SERVICE> 354J. The tag 354H includes an attribute ID=“ID2”, which is an alias for the URI for another target service defined between tags 354H, 354J at line 354I. A tag <TARGET> and its companion ending tag </TARGET> contain the URI “SOAP://DEV/B/”.

The message 354 includes instructions between tag <PROCESS> 354K and its companion ending tag </PROCESS> 354M for the message dispatcher 330 to distribute the message. Between tag 354K and tag 354M is a behavioral sentence: “ID1|ID2 .0”, where ID1 denotes the sending of the delete action to a service; the parallel symbol “|” denotes that the sending of the delete action to a service identified by ID1 is concurrent with another process defined by a term on the other side of the parallel symbol; the term ID2 identifies the other service to be sent the delete action in parallel with the service identified by ID1; the period symbol “.” denotes that after sending the delete action to both the service identified by ID1 concurrently with the service identified by ID2, another process will follow; and the term zero “0” denotes the termination of the behavior.

The message dispatcher 330 can be viewed as a port that first receives all messages in the decentralized operating system 302A. Using a target service URI expressed in the header of a message, the message dispatcher 330 forwards the message, such as the message 354, to a target service, such as the service 313A or the service 310A. After the target service has registered with the URI manager 328, the target service becomes alive and blocks processing to listen for messages forwarded by the message dispatcher 330. Suppose that the message dispatcher 330 sends the message 354 to the service 313A. The service 313A becomes unblocked and looks to see what type of message it is. If the service 313A cannot process the message, the service 313A blocks processing and listens for further messages. Otherwise, the message is of an appropriate type, the service 313A then processes the message.

As discussed, when a service wants to send a message to a target service, the service creates a SOAP compliance XML message and passes the message to the message dispatcher 330. If the target service is local, the message dispatcher 330 passes the message directly to the service. Otherwise, if the target service is remote, the message dispatcher 330 passes the message to the network manager 332 for transmission to another computer system. When a message arrives from the network, the network manager 332 passes the message to the message dispatcher 330. The message dispatcher 330 in turn checks the URI manager 328 to determine which service should receive the message. If no service is registered as the destination of a particular message, that particular message is discarded.

FIG. 3L illustrates the network manager 332 in greater detail. The network manager 332 includes a serializer/deserializer 332A, a control/data plane separator 332B, and a transmission protocol processor 332C. These components 332A-332C process a message for transmission over the network 320. The network manager 332 provides the interface between the message dispatcher 330 and the network 320. The network manager 332 accepts a SOAP compliance XML message from the message dispatcher 330; serializes the message using the serializer/deserializer 332A; and encapsulates the message, using the transmission protocol processor 332D, in an underlying protocol for transmission across the network 320. The network manager 332 also accepts a serialized SOAP compliance message formatted in the appropriate underlying protocol from the network 320; extracts the serialized SOAP compliance message using the serializer/deserializer 332A; constitutes the original SOAP compliance message; and hands the message to the message dispatcher 330 for further distribution. The network manager 332 manages protocol connections (such as TCP connections) using the transmission protocol processor 332D. The transmission protocol processor 332D controls the setup and teardown of TCP connections.

A portion of an exemplary message 356 includes a root tag <MESSAGE> 356A and its companion ending tag </MESSAGE> 3560. Tags 356A, 3560, define a message to be processed by the network manager 332. Enclosed between tags 356A, 3560 are two sections, a header and a body. The header is defined between a tag <HEADER> 356B and its companion ending tag </HEADER> 356K. A pair of tags <VERB> 356C and </VERB> 356G define an action to be taken by a target service sent by a source service, which is the original sender of the message 356. Enclosed between tags 356C, 356G are an <ACTION/> tag 356D for defining a particular action; a <SOURCEURI/> tag 356E for defining the URI of the service that sent the message 356; and a <TARGETURI/> tag 356F for defining the URI of a service to receive the message 356. A tag <BUFFER> 356H and its companion ending tag </BUFFER> 356J define one or more references of memory buffers into which data can be filled or out of which data can be taken. A tag <BUFFERURI/> 356I defines the URI that is assigned to a particular memory buffer so that the data can be transferred by reference rather than by value. In other words, by assigning URIs to memory buffers using the URI manager 328, memory buffers can be referenced between a service at one computer system and another service at another computer system without actually transferring the data across the network 320. The control/data plane separator 332B aids in separating the control aspect of the message 356 from its data aspect. The tag 356H includes an attribute ID=“ID1”, which acts as the reference to the memory buffer described by the tag 356I. The message 356 includes the body defined between a tag <BODY> 356L and its companion ending tag </BODY> 356N. The referenced memory buffer in the header defined between tags 356B, 356K can be used to describe the operation to be performed on the memory buffer. A tag <DATA> 356M includes an attribute HREF=“#ID1”. The term HREF is a compound term for hypertext reference, which is an attribute in a Web document that defines a link to another document on the Web. In this instance, it is used to refer to a memory buffer via its reference ID1, which is identifiable by an identifier that includes a URI as noted by the tag 356I.

To enhance performance of computer systems on which decentralized operating systems run, such as the decentralized operating systems 302A-B, two types of information flow are separated by the control/data plane separator 332B. The size of control information is typically small to facilitate quick communication over the network 320. The size of data information is typically larger, creating greater difficulty transferring over the network 320. Instead of transferring data information with every communication among services across the network 320, the control/data plane separator 332B allows the interpretation of data information that has been abstracted into references. These references can be described in messages as if data were present in the messages. These references can be sent along the control plane or flow, thus enhancing performance. One exemplary application is the use of such a separation in data intensive devices, such as a hard disk or a monitor display.

FIG. 3M illustrates the concept of synchronization through communication among services, such as the services 310A, 310B, and 310D. These three services 310A, 310B, 310D include unilateral contracts 310A-2, 310B-2, and 310D-2 and ports identified by URIs 310A-1, 310B-1, and 310D-1. Suppose that the service 310B sends a READ message to the service 310A during which the service 310D sends a WRITE message 358B to the service 310A. If the WRITE message 358B occurs concurrently with the READ message 358A, the data read by the READ message 358A may be unpredictable. There is a need to synchronize accesses to the service 310A to prevent unpredictable outcomes for both the service 310B and the service 310D.

Traditionally, to synchronize access, threads, mutual exclusions, critical sections, semaphores, spin locks, and so on were used to regulate accesses to a resource. In various embodiments of the present invention, synchronization occurs via blocking or unblocking of messages received at a port associated with a particular URI, such as the URI 310A-1, without the need to use threads, mutual exclusions, critical sections, semaphores, spin locks, and so on. When the service 310A receives a READ message 358A from the service 310B, it blocks the WRITE message 358B sent by the service 310D.

This technique of synchronizing messages allows accesses to resources to be regulated even if the three services 310A, 310B, and 310D are located together on a particular computer system or distributed among multiple computer systems. Thus, synchronizing by blocking and unblocking messages aids in the decentralization of resources yet ensures that accesses to resources happen in an orderly manner without contentions from services.

FIG. 3N illustrates concurrency of the decentralized operating system 302 via instantiation of ports. When the service 310D issues a READ message 360B to the operating system 310A, the service 310D communicates with the service 310A via the port identified at the URI 310A-1. Suppose that the service 310B also issues a READ message 360A to the service 310A. The communication between the service 310B and 310A occurs via a newly created port identified by a URI 310A-3 associated with a unilateral contract 310A-4 instead of the port identified by the URI 310A-1.

Because synchronized ports of communication for services are mapped to URIs and can be exposed on the Internet, a preferred concurrent method to support messages (such as reading and writing) sent by multiple services is via instantiation of each port per session. When a calling service attempts to use a resource (such as the service 310A), instead of directly supporting the service at only one port identified by a URI, a port with another URI is created for that specific session. Preferably, this method is carried out by the simplest compositions of services to more complex compositions of services.

FIG. 3O illustrates the visibility of the behaviors of services, which allows them to be inspected by other services. Suppose that the service 310A has a read-only file opened. That is represented by a file service 310I, which has a port identified by a URI 310I-1 and a unilateral contract 310I-2. A portion 310I-2A of the unilateral contract 310I-2 is expressed as follows: REC F(READ.F+DROP) .0, where the term “REC F” indicates a recursion on a behavior F; the term READ indicates a READ operation; the period symbol “.” denotes that the READ operation is followed by another behavior; the term F indicates that the behavior F is executed following the execution of the READ operation; the plus sign symbol “+” denotes a choice between the behavior phrase READ.F and another behavior phrase to follow the plus sign; the term DROP indicates an execution of the DROP operation; the pair of parentheses indicate that the behavior phrase inside the parentheses has priority and will be processed first; and the phrase .0 indicates that after the behavior phrase inside the parentheses is executed, the behavior will terminate execution.

Suppose that the service 310B attempts to open the same file (for both reading and writing) that the service 310A has opened read-only. The attempt by the service 310B to open the file for both reading and writing fails. To understand why such an operation has failed, the service 310B can query either the service 310 or the file service 310D to obtain the unilateral contract 310I-2 and determine that the file service is presently read-only.

A resource, such as a hard disk, need not be represented by a single service. A composition of services can be formed representing the resource. FIG. 3Q illustrates an abstraction of a hard disk into four different logical services. A controller 358B with its unilateral contract 358B-2 and its port identified at a URI 358B-1 represents the controlling mechanism of the hard disk. A service 358C with its unilateral contract 358C-2 and its port identified at a URI 358C-1 represents the content or the media stored on the hard disk. A service 358D and its unilateral contract 358D-2 and its port identified at a URI 358D-1 represent the power circuitry of the hard disk. The fourth service 358A and its unilateral contract 358A-2 and port identified at a URI 358A-1 represent various physical behaviors among services 358B-358D for which no messages can be sent.

The unilateral contract 358A-2 expresses implicit interactions and relationships of the logical components 358B-358D even if there were no active messages passed between the components. Although a hard disk comprises one physical device, the three components 358B-358D are interconnected because if the power were to be removed from any one component then all components should be inactivated. The fact that power is removed does not necessarily involve sending a message to the three components. However, such a dependency can be captured and expressed in the unilateral contract 358A-2, which maps the graphing relationship between the logical components 358B-358D.

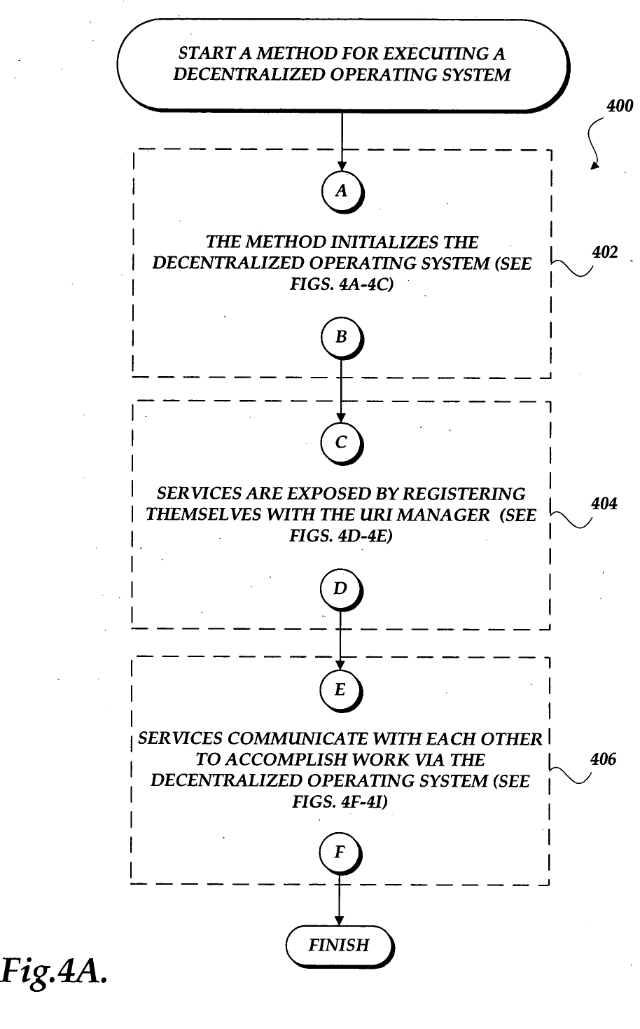

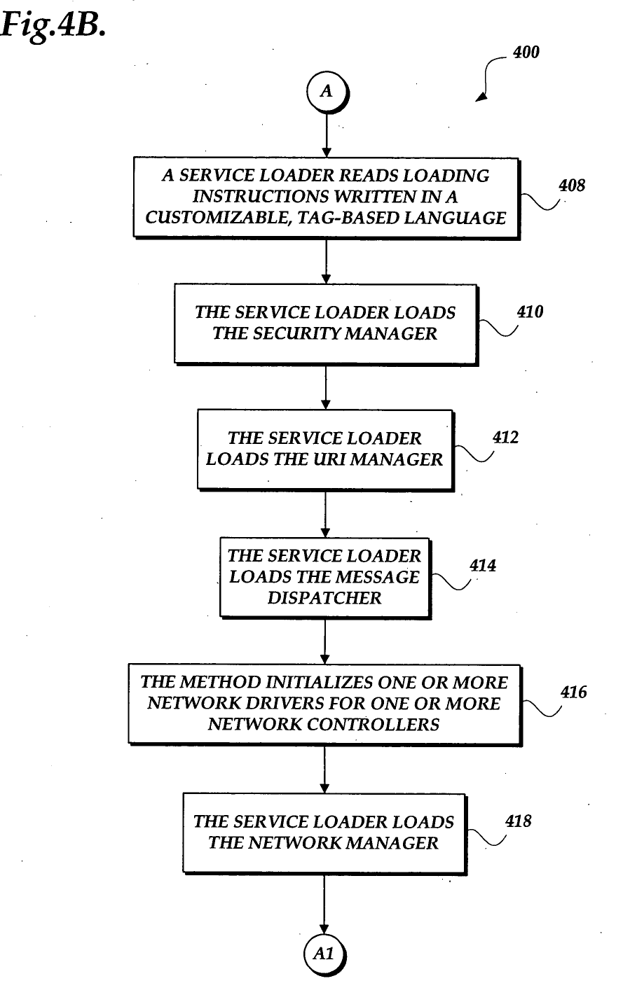

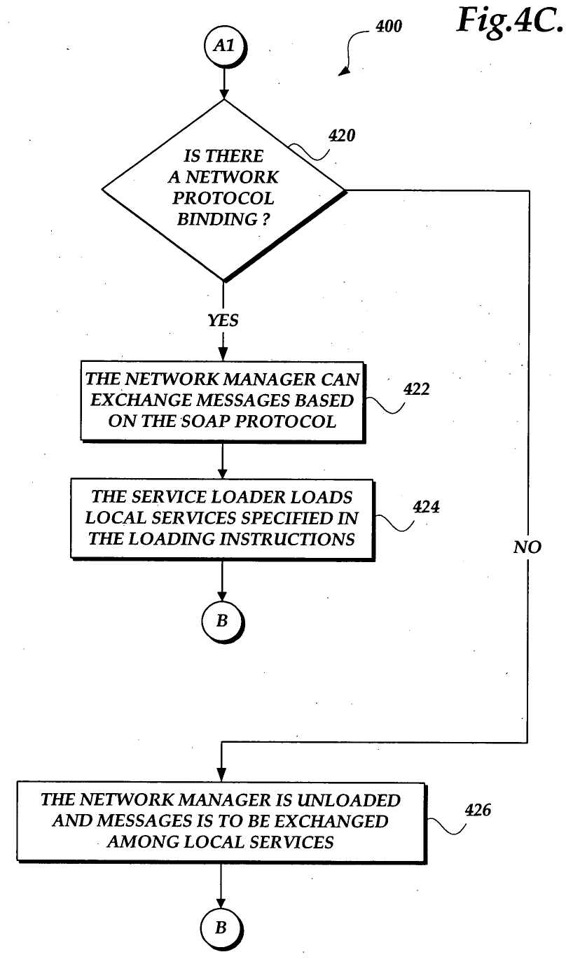

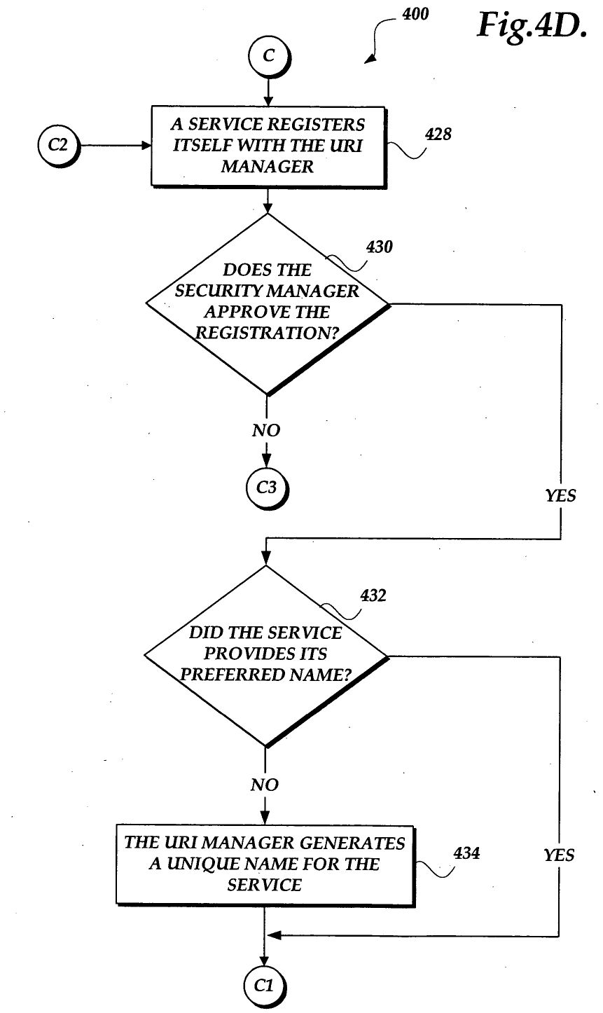

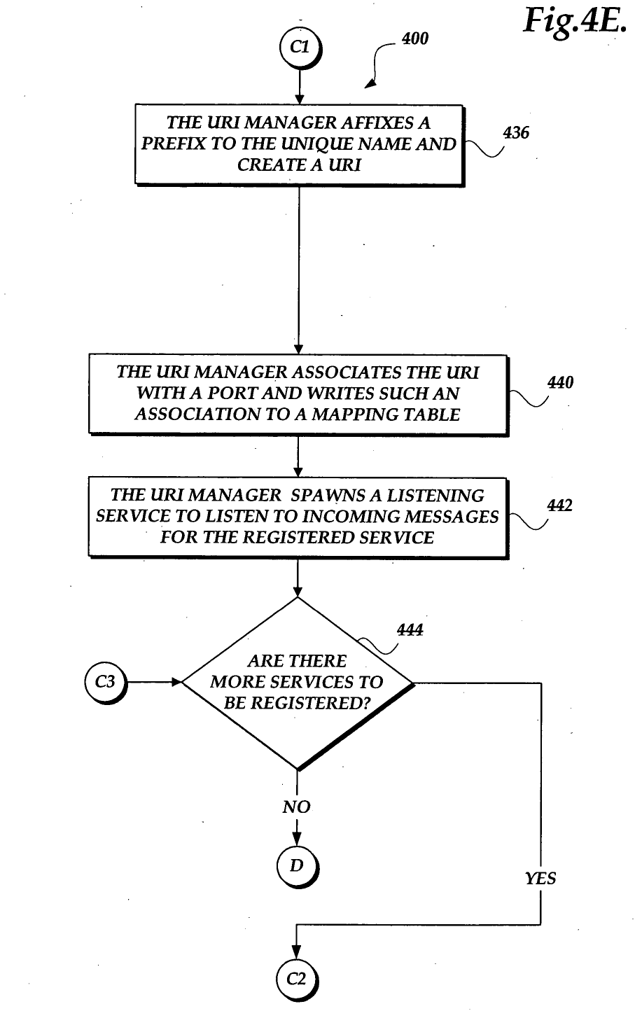

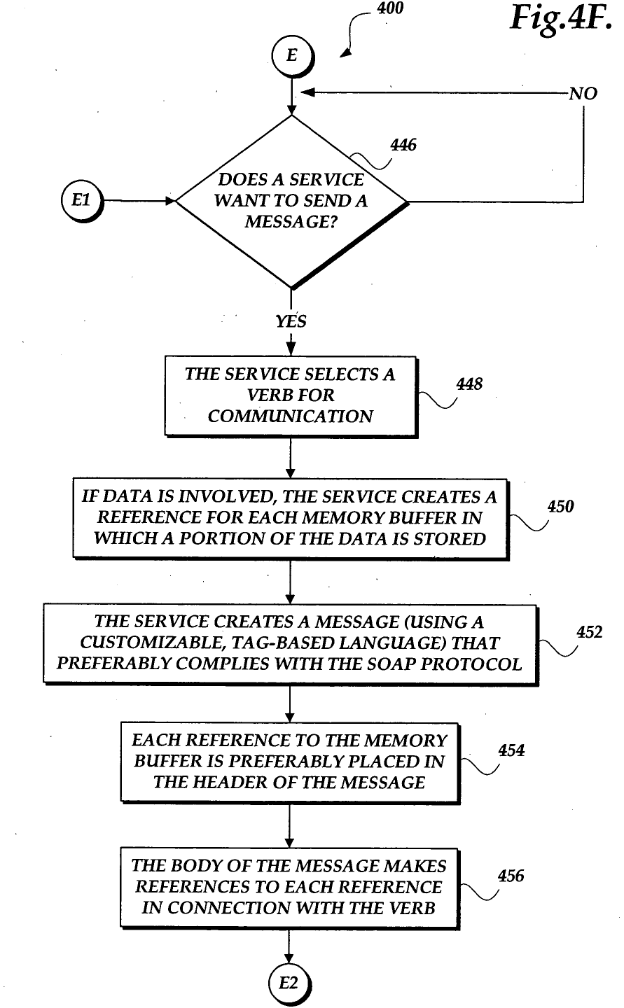

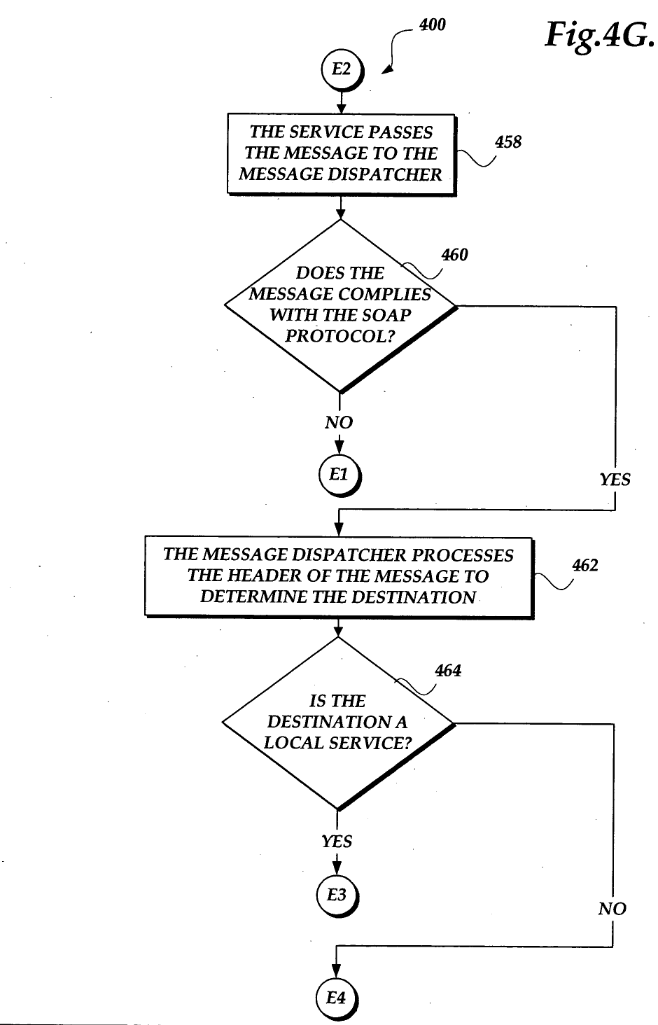

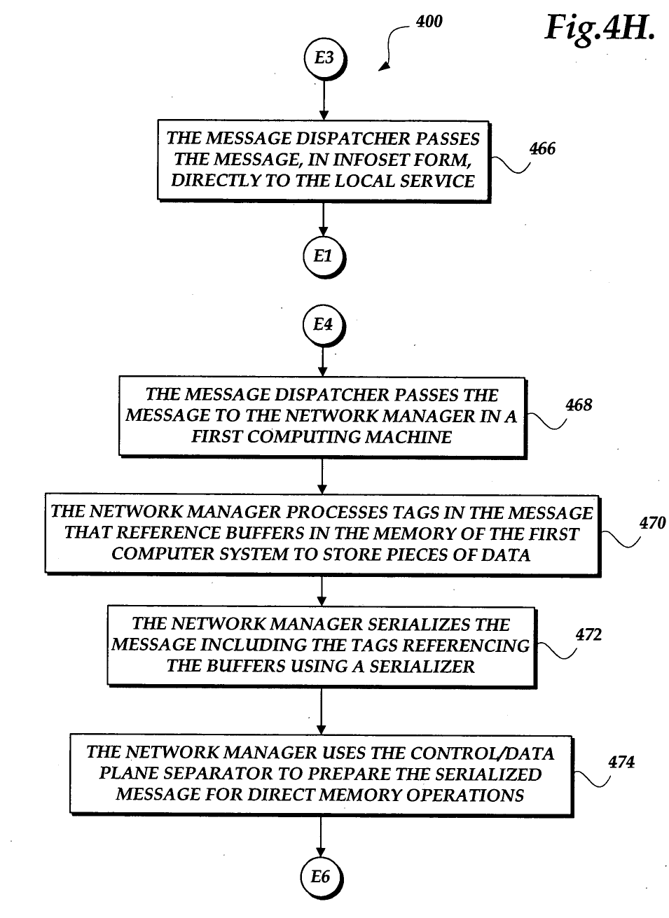

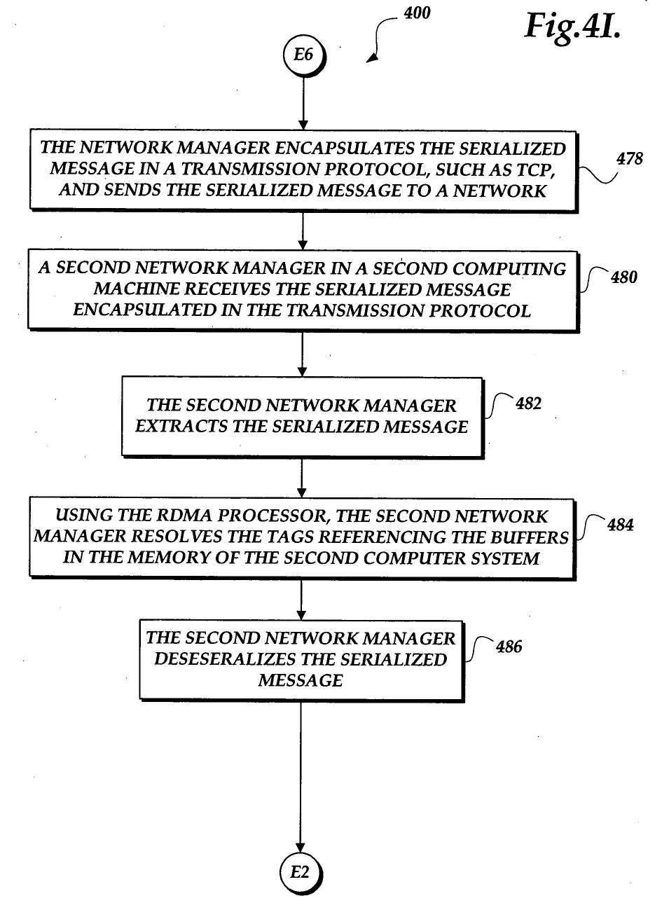

FIGS. 4A-4I illustrate a method 400 for executing a decentralized operating system. For clarity purposes, the following description of the method 400 makes reference to various elements illustrated in connection with the decentralized operating system 302 (FIGS. 3A, 3E and 3G), the distributing kernel 302A-1 (FIG. 3H), the service loader 324 (FIG. 3I), the URI manager 328 (FIG. 3J), the message dispatcher 330 (FIG. 3K), the network manager 332 (FIG. 3L), and services (FIG. 3B). From a start block, the method 400 proceeds to a set of method steps 402, defined between a continuation terminal (“terminal A”) and an exit terminal (“terminal B”). The set of method steps 402 describes the initialization of the decentralized operating system 302.

From terminal A (FIG. 4B), the method 400 proceeds to block 408 where the service loader 324 reads loading instructions, which are written preferably in a customizable, tag-based language (see loading instructions 334). Next, the service loader 324 loads the security manager 326. See block 410. The service loader 324 loads the URI manager 328. See block 412. At block 414, the service loader 324 loads the message dispatcher 330. The method 400 proceeds to block 416 and initializes one or more network drivers for one or more network controllers. The network manager 332 is loaded by the service loader 324. See block 418. The method 400 enters another continuation terminal (“terminal A1”).

From terminal A1, at a decision block entered by the method 400, a test is made to determine whether there is a network binding protocol. See decision block 420. If the answer is YES to the test at decision block 420, the network manager 332 can exchange messages based on the SOAP protocol as illustrated at block 422. Next, the method 400 proceeds to block 424 where the service loader 324 loads local services specified in the loading instructions 334. The method 400 then proceeds to the exit terminal B. If the answer to the test at decision block 420 is NO, the network manager 332 is unloaded and messages are to be exchanged among local services with no connection to the network 320. See block 426. The method 400 then enters the exit terminal B.

From the exit terminal B (FIG. 4A), the method 400 proceeds to a set of method steps 404, defined between a continuation terminal (“terminal C”) and an exit terminal (“terminal D”). The set of method steps 404 describes the acts by which services are exposed by registering themselves with the URI manager 328.

From terminal C (FIG. 4D), the method 400 proceeds to block 428 where a service, such as the services 310A, 310B, registers itself with the URI manager 328 (see FIG. 3J). See block 428. Next, a test is made to determine whether the security manager 326 approved the registration. See decision block 430. If the answer to the test at decision block 430 is NO, another continuation terminal (“terminal C3”) is entered.

If the answer to the test at decision block 420 is YES, the method 400 proceeds to decision block 432 where another test is made to determine whether the service provided its preferred name to the URI manager 328. If the answer to the test at decision block 432 is NO, the URI manager 328 generates a unique name for the service. See block 434. If the answer to the test at decision block 432 is YES, the method proceeds to another continuation terminal (“terminal C1”). The method 400 from block 434 also continues on to the terminal C1.

From terminal C1 (FIG. 4E), the method 400 proceeds to block 436 where the URI manager 328 affixes a prefix, such as a host name, to the unique name and creates a URI. The URI manager 328 then associates the URI with a port and writes such an association to a mapping table, such as the registry 352. Next, the method 400 proceeds to block 442 where the URI manager 328 spawns a listening service to listen to incoming messages for registered services.

Next, decision block 444 is entered by the method 400 where a test is made to determine whether there are more services to be registered. If the answer is NO, the method 400 proceeds to the exit terminal D. If the answer is YES, the method 400 proceeds to another continuation terminal (“terminal C2”). From terminal C2 (FIG. 4D), the method 400 loops back to block 428 where the above processing steps are repeated.

From the exit terminal D (FIG. 4A), the method 400 proceeds to a set of method steps 406, defined between a continuation terminal (“terminal E”) and an exit terminal (“terminal F”). The set of method steps 406 describe the communication among services to accomplish work via a decentralized operating system, such as the decentralized operating systems 302A, 302B.

From terminal E (FIG. 4F), the method 400 proceeds to decision block 446 where a test is made to determine whether the service wants to send a message. If the answer is NO to the test at decision block 446, the method 400 loops back and executes the decision block 446 again. If the answer is YES, the method 400 proceeds to block 448 where a service selects a message type for communication. Next, at block 450, if data is involved, the service creates a reference for each memory buffer in which a portion of the data is stored. The service then creates a message (preferably using a customizable, tag-based language) that preferably complies with the SOAP protocol. See block 452. The method 400 then proceeds to block 454 where each reference to the memory buffer is preferably placed in the header of the message. Next, at block 456, the body of the message makes references to each reference in connection with the message type. From here, the method 400 proceeds to another continuation terminal (“terminal E2”).

From terminal E2 (FIG. 4G) the method 400 proceeds to block 458 where the service passes the message to the message dispatcher 330. See block 458. The method 400 then proceeds to decision block 460 where a test is made to determine whether the message complies with the SOAP protocol. If the answer is NO to the test at decision block 460, the method 400 proceeds to another continuation terminal (“terminal E1”). From terminal E1 (FIG. 4F), the method 400 loops back to decision block 446 where the above-described processing steps are repeated.

If the answer to the test at decision block 460 is YES, the message dispatcher 330 processes the header of the message to determine the destination of the message (another service). See block 462. Next, the method 400 proceeds to decision block 464 where another test is made to determine whether the destination is a local service. If the answer to the test at decision block 464 is YES, another continuation terminal is entered (“terminal E3”). If the answer to the test at decision block 464 is NO, another continuation terminal is entered by the method 400 (“terminal E4”).

From terminal E3 (FIG. 4H), the message dispatcher 330 passes the message (preferably in infoset form of the original SOAP compliance XML message) directly to the local service. See block 466. The method 400 then proceeds to terminal E1 where the method 400 loops back to decision block 446 and the above-described processing steps are repeated.

From terminal E4 (FIG. 4H), the method 400 enters block 468 where the message dispatcher 330 passes the message to the network manager 332 in a first computer system. For example, the first computer system includes a machine that executes the decentralized operating system 302A. The method 400 then proceeds to block 470 where the network manager 332 processes tags in the message that reference buffers in the memory of the first computing machine to store pieces of data. See the control/data plane separator 332B. The network manager 332 then serializes the message including the tags referencing the buffers using a serializer 332A. See block 472. Next, the network manager uses the control/data plane separator 332B to prepare the serialized message for transfer operations. See block 474. The method 400 then continues to another continuation terminal (“terminal E6”).

From terminal E6 (FIG. 4I), the method 400 proceeds to block 478 where the network manager 332 encapsulates the serialized message in a transmission protocol, such as TCP, and sends the serialized message to a network using a transmission protocol processor 332C. A second network manager in a second computer system receives the serialized message encapsulated in the transmission protocol. See block 480. The second network manager then extracts the serialized message using a corresponding serializer 332A. See block 482. Using a second control/data plane separator 332B, the second network manager resolves the tags referencing the buffers in the memory of the second computing machine. See block 484. The second network manager then deserializes the serialized message. See block 486. The method 400 then continues to terminal E2 (FIG. 4G) where the above processing steps are repeated for the second computer system.

While the preferred embodiment of the invention has been illustrated and described, it will be appreciated that various changes can be made therein without departing from the spirit and scope of the invention.

1. A computer system, comprising:
services for representing resources, each service including a designation primitive, a behavioral primitive that comprises a unilateral contract, and a communication primitive; and
a decentralized operating system for orchestrating the services executing on the computer system so as to control and coordinate resources.

2. The computer system of claim 1, wherein the computer system includes a microcomputer, a personal digital assistant, a cellular phone, or a display.

3. The computer system of claim 1, wherein the designation primitive includes a port identifiable by an identifier that includes a uniform resource identifier.

4. The computer system of claim 3, wherein the port is endued with a behavior type as specified by a unilateral contract.

5. The computer system of claim 1, wherein a unilateral contract of the behavioral primitive defines a protocol for exchanging messages in a particular order with a service to whom the unilateral contract belongs.

6. The computer system of claim 5, wherein the communication primitive includes a set of message types usable in the messages exchanged among services so as to call a service to perform a certain task.

7. The computer system of claim 6, wherein the decentralized operating system separates the control information from the data information in the messages when the messages are exchanged.

8. The computer system of claim 1, wherein services include services.

9. A networked system for networking computer systems, comprising:
a first decentralized operating system executing on a computer system, which includes:
a first distributing kernel for designating uniform resource identifiers for a first set of services and distributing messages among the first set of services, each service including a unilateral contract, the unilateral contract expressing behaviors of the service.

10. The networked system of claim 9, wherein services includes device drivers for devices.

11. The networked system of claim 9, further comprising a process kernel for communicating messages as processes among services.

12. The networked system of claim 10, further comprising an operating system kernel for managing memory, controlling devices, maintaining time and date, and allocating system resources.

13. The networked system of claim 9, further comprising a network coupled to the first computer system, the network is selected from a group consisting of high bandwidth, low latency systems; high bandwidth, high latency systems; low bandwidth, high latency systems; and low bandwidth, low latency systems.

14. The networked system of claim 13, further comprising a second decentralized operating system executing on another computer system coupled to the network, which includes: a second distributing kernel for designating uniform resource identifiers for a second set of services and distributing messages among the second set of services, each service including a unilateral contract, the unilateral contract expressing behaviors of the service.

15. The networked system of claim 14, wherein a resource being represented as a service from the second set of services is orchestrated by the first distributing operating system.

16. The networked system of claim 14, wherein a service from the second set of services registers with the first distributing kernel to obtain a uniform resource identifier.

17. The networked system of claim 14, wherein the first distributing kernel distributes a message to a service from a first set of service, the message being sent by a service from a second set of services.

18. The networked system of claim 14, wherein the first decentralized operating system orchestrates a composition of a service from a first set of services and a service from a second set of services.

19. A computer system, comprising:
a decentralized operating system that includes a distributing kernel, comprising:
a URI manager for managing names, each name constituting a unique designation of a service at the computer system so that the service can be discovered; and
a message dispatcher for forwarding messages among services, each service being identifiable by a name managed by the URI manager, each service being associated with a unilateral contract.

20. The computer system of claim 19, wherein the distributing kernel further comprises a security manager for controlling authentication and authorization of rights and restrictions among services.

21. The computer system of claim 19, wherein the distributing kernel further comprises a service loader for executing a sequence of instructions for loading components and services, the service loader being capable of dynamically loading or unloading services during the operation of the decentralized operating system.

22. The computer system of claim 19, wherein the URI manager receives a register message from a service to obtain a unique designation and assigns the unique designation to the service, the URI manager being capable of receiving an unregister message for removing an assigned unique designation from a registry.

23. The computer system of claim 19, wherein the message dispatcher forwards a message from a first service to a second service if the first service has a first uniform resource identifier assigned by the URI manager and the second service has a second uniform resource identifier assigned by the URI manager.

24. The computer system of claim 19, wherein the message dispatcher includes a message validity verifier for verifying that a message sent to the message dispatcher is a message whose structure complies with the SOAP protocol.

25. The computer system of claim 19, further comprising a network manager for distributing messages forwarded by the message dispatcher to another computer system.

26. The computer system of claim 25, wherein the network manager comprises a serializer/deserializer, a transmission protocol processor, and a control/data plane separator.

27. A method implemented on a computer system, comprising:
assigning a first unique name to a first service upon request, the first service including a first unilateral contract for expressing the behaviors of the first service; and
distributing a message to the first service using the unique name, the message being sent by a second service having a second unique name, the second service including a second unilateral contract for expressing the behaviors of the second service.

28. The method of claim 27, further comprising loading a network manager and other services according to instructions written in a customizable, tag-based language.

29. The method of claim 28, further comprising spawning a service to listen for incoming messages for the first service that has been assigned the first unique name.

30. The method of claim 29, further comprising rejecting the message without distributing the message if a structure of the message fails to comply with a protocol for exchanging structured and type information of messages written in a customizable, tag-based language.

31. The method of claim 30, further comprising forwarding the message to the first service without routing the message through the network manager if the first service and the second service runs on a computer system.

32. The method of claim 30, further comprising forwarding the message to the first service by routing the message through the network manager if the first service runs on a first computer system whereas the second service runs on a second computer system.

33. The method of claim 32, wherein the act of forwarding including transmitting data information separately from transmitting control information.

34. The method of claim 33, wherein the act of transmitting includes transmitting data information in accordance with transmitted control information.

35. A computer-readable medium having instructions thereon for implementing a method, the method comprising:
assigning a first unique name to a first service upon request, the first service including a first unilateral contract for expressing the behaviors of the first service; and
distributing a message to the first service using the unique name, the message being sent by a second service having a second unique name, the second service including a second unilateral contract for expressing the behaviors of the second service.

36. The computer-readable medium of claim 35, further comprising loading a network manager and other services according to instructions written in a customizable, tag-based language.

37. The computer-readable medium of claim 36, further comprising spawning a service to listen for incoming messages for the first service that has been assigned the first unique name.

38. The computer-readable medium of claim 37, further comprising rejecting the message without distributing the message if a structure of the message fails to comply with a protocol for exchanging structured and type information of messages written in a customizable, tag-based language.

39. The computer-readable medium of claim 38, further comprising forwarding the message to the first service without routing the message through the network manager if the first service and the second service runs on a computer system.

40. The computer-readable medium of claim 38, further comprising forwarding the message to the first service by routing the message through the network manager if the first service runs on a first computer system whereas the second service runs on a second computer system.
